(19) United States
(12) Patent Application Publication
(10) Pub. No.: US 2026/0035562 A1
(43) Pub. Date: Feb. 5, 2026

(54) POLYAMIDES HAVING HIGH LEVELS OF AMINE END GROUPS

(71) Applicant: Ascend Performance Materials Operations LLC, Houston, TX (US)

(72) Inventors: Bradley J. Sparks, Houston, TX (US); Ryan M. Hensarling, Houston, TX (US)

(21) Appl. No.: 19/353,860

(22) Filed: Oct. 9, 2025

Related U.S. Application Data
(63) Continuation of application No. 16/783,582, filed on Feb. 6, 2020, now abandoned.
(60) Provisional application No. 62/801,869, filed on Feb. 6, 2019.

(51) Int. Cl. C08L 77/06; C08K 3/04; C08K 3/22; C08K 5/00; C08K 5/07; C08K 5/56; C08K 7/14

(52) U.S. Cl. CPC C08L 77/06; C08K 3/04; C08K 3/22; C08K 5/0041; C08K 5/07; C08K 5/56; C08K 7/14; C08K 2003/2213; C08K 2003/2248; C08L 2201/08; C08L 2205/02; C08L 2310/00

(57) ABSTRACT

A heat-stabilized polyamide composition comprising from 25 wt % to 99 wt % of an amide polymer having an amine end group level greater than 50 μeq/gram; a first stabilizer comprising a lanthanoid-based compound; a second stabilizer; e.g., a copper-based stabilizer (for stabilizing the composition); and from 0 wt % to 65 wt % filler, e.g., glass (for filling the composition); wherein, when heat aged for 3000 hours over a temperature range of from 190° C. to 220° C., the polyamide composition demonstrates a tensile strength retention of greater than 51%, as measured at 23° C.

### CROSS REFERENCE TO RELATED APPLICATION

The present application is a continuation of U.S. Non-Provisional application Ser. No. 16/783,582, filed Feb. 6, 2020, titled “POLYAMIDES HAVING HIGH LEVELS OF AMINE END GROUPS,” which claims priority to, and the benefit of U.S. Provisional Application No. 62/801,869, filed Feb. 6, 2019, titled “POLYAMIDES HAVING HIGH LEVELS OF AMINE END GROUPS,” which are incorporated herein by reference in their entirety.

### FIELD

The present disclosure relates to the stabilization of polyamides, particularly against heat degradation, to the additives used in such stabilization, and to the resultant stabilized polymeric compositions.

### BACKGROUND

Conventional polyamides are generally known for use in many applications including, for example, textiles, automotive parts, carpeting, and sportswear.

In some of these applications, the polyamides in question may be exposed to high temperatures, e.g., on the order of 150° C. to 250° C. It is known that, when exposed to such high temperature, a number of irreversible chemical and physical changes affect the polyamide, which manifest themselves through several disadvantageous properties. The polyamide may, for example, become brittle or discolored. Furthermore, desirable mechanical properties of the polyamide, such as tensile strength and impact resilience, typically diminish from exposure to high temperatures. Thermoplastic polyamides, in particular, are frequently used in the form of glass fiber-reinforced molding compounds in construction materials. In many cases, these materials are subjected to increased temperatures, which lead to damage, e.g., thermooxidative damage, to the polyamide.

In some cases, heat stabilizers or heat stabilizer packages may be added to the polyamide mixture in order to improve performance, e.g., at higher temperatures. The addition of conventional heat stabilizer packages has been shown to retard some thermooxidative damage, but typically these heat stabilizer packages merely delay the damage and do not permanently prevent it. In addition, some (most) conventional stabilizer packages have been found to be ineffective over higher temperature ranges, e.g., over particular temperature gaps.

In addition, conventional stabilizer packages have been found to be ineffective over higher temperature ranges, e.g., over particular temperature gaps such as from 180° C. to 240° C. or from 190° C. to 220° C. Importantly, the 190° C. to 220° C. temperature range, is a range over which a reduction in polyamide tensile properties (of polyamide stabilized with conventional heat stabilizer packages) is commonly seen. This temperature range is particularly important, as it relates to many automotive engine-related applications. Stated another way, many known stabilizer packages yield polyamides that have stability/performance gaps over broad temperature ranges. For example, polyamides that employ copper-based stabilizers yield polyamides that have performance gaps at temperatures above 180° C., e.g., above 190° C. Similarly, polyamides that employ polyol-based stabilizers yield polyamides that have performance gaps at temperatures above 190° C., e.g., above 210° C. Further, polyamide compositions that employ a minor portion of caprolactam-containing polymers, have been found to perform well at higher temperatures, e.g., over 240° C., but perform poorly in the 180° C. to 210° C. gap. Thus, when polyamides are exposed to these temperatures, the polyamides perform poorly, e.g., in terms of tensile strength and/or impact resilience, inter alia.

Further, while many of these stabilizers may improve performance at some temperatures, each stabilizer package often presents its own set of additional shortcomings. Stabilizer packages that utilize iron-based stabilizers, for example, are known to require a high degree of precision in the average particle size of the iron compound, which presents difficulties in production. Furthermore, these iron-based stabilizer packages demonstrate stability issues, e.g., the polyamide may degrade during various production stages. As a result, the residence time during the various stages of the production process must be carefully monitored. Similar issues are present in polyamides that utilize zinc-based stabilizers.

As one example of a conventional stabilized composition, EP 2535365A1 discloses a polyamide molding compound comprising: (A) a polyamide mixture (27-84.99 wt %) comprising (A1) at least one semiaromatic, semicrystalline polyamide having a melting point of 255-330° C., and (A2) at least one caprolactam-containing polyamide that is different from the at least one semiaromatic, semicrystalline polyamide (A1) and that has a caprolactam content of at least 50 wt %; (B1) at least one filler and reinforcing agent (15-65 wt %); (C) at least one thermal stabilizer (0.01-3 wt %); and (D) at least one additive (0-5 wt %). The polyamide molding compound comprises: (A) a polyamide mixture (27-84.99 wt %) comprising (A1) at least one semiaromatic, semicrystalline polyamide having a melting point of 255-330° C., and (A2) at least one caprolactam-containing polyamide that is different from the at least one semiaromatic, semicrystalline polyamide (A1) and that has a caprolactam content of at least 50 wt %. The sum of the caprolactam contained in polyamide (A1) and polyamide (A2) is 22-30 wt %, with respect to the polyamide mixture. The polyamide mixture further comprises: (B1) at least one filler and reinforcing agent (15-65 wt %); (C) at least one thermal stabilizer (0.01-3 wt %); and (D) at least one additive (0-5 wt %). No metal salts and/or metal oxides of a transition metal of the groups VB, VIB, VIIB or VIIIB of the periodic table are present in the polyamide molding compound.

GB 904,972 discloses a stabilized polyamide containing as stabilizers 0.5 to 2% by weight of hypophosphoric acid and/or a hypophosphate and 0.001 to 1% by weight of a water soluble cerium (III) salt and/or a water-soluble titanium (III) salt. Specified hydrophosphates are lithium, sodium, potassium, magnesium, calcium, barium, aluminium, cerium, thorium, copper, zinc, titanium, iron, nickel and cobalt hypophosphates. Specified water-soluble cerium (III) and titanium (III) salts are the chlorides, bromides, halides, sulphonates, formates and acetates. Specified polyamides are those derived from caprolactam, caprylic lactam, o-amino-undecanoic acid, the salts of adipic, suberic, sebacic or decamethylene dicarbonic acid with hexamethylene or decamethylene diamine, of heptane dicarboxylic acid with bis-(4-aminocyclohexyl)-methane, of tetramethylene diisocyanate and adipic acid and of aliphatic w-aminoalcohols and dicarboxylic acids each with 4 to 34 carbon atoms between the functional groups. The stabilizers may be added to the polyamides during or after the polycondensation reaction. Delustrants, e.g. cerium dioxide, titanium dioxide, thorium dioxide or ytrium trioxide may also be added to the polyamides. Examples (1) and (2) describe the polymerization of:—(1) hexamethylene diammonium adipate in the presence of disodium dihydrogen hypophosphate hexahydrate and (a) titanium (III) chloride hexahydrate, (b) cerium (III) chloride; (2) caprolactam in the presence of (a) thorium hypophosphate and titanium (III) chloride hexahydrate, whilst in Example (3) polycaprylic lactam is mixed with tetrasodium hypophosphate, titanium (III) acetate and titanium dioxide.

Also, EP 1832624A1, discloses the use of a radical catcher for the stabilization of organic polymer against photochemically, thermally, physically and/or chemically induced dismantling through free radical, preferably against UV-light exposure. Cerium dioxide is used as an inorganic radical catcher. Independent claims are included for: (1) a polymer composition comprising cerium dioxide, a UV-absorber and/or a second radical catcher; (2) agent for the stabilization of organic polymer comprising a combination of cerium dioxide, a UV-absorber and/or at least a second radical catcher; and (3) a procedure for the stabilization of organic polymer, preferably in the form of polymer based formulation, lacquer, color or coating mass against photochemically, thermally, physically and/or chemically induced dismantling through free radical, comprising mixing cerium dioxide as inorganic radical catcher, optionally in combination with the UV-absorber or with the second radical catcher.

And, U.S. Pat. No. 9,969,882 discloses polyamide molding compounds which have an improved resistance to heat-aging and comprise the following compositions: (A) 25 to 84.99 wt. % of at least one polyamide, (B) 15 to 70 wt. % of at least one filler and reinforcing means, (C) 0.01 to 5.0 wt. % of at least one inorganic radical interceptor, (D) 0 to 5.0 wt. % of at least one heat stabilizer which is different from the inorganic free-radical scavenger under (C), and (E) 0 to 20.0 wt.-% of at least one additive. The invention further relates to molded articles produced from these polyamide molding compounds as components in the automobile or electrics/electronics sector.

Even in view of the references, the need exists for improved polyamide compositions that demonstrate superior performance over a broad temperature range, in particular, that demonstrates significant improvements in tensile strength and impact resilience (among other performance characteristics) at higher temperature ranges, e.g., above 190° C. or from 190° C. to 220° C.

### BRIEF DESCRIPTION OF THE DRAWINGS

FIG. 1 is a graph showing the tensile strength retention achieved by an embodiment of the disclosed composition at 2500 hours heat age.

FIG. 2 is a graph showing the tensile strength retention achieved by an embodiment of the disclosed composition at 3000 hours heat age.

### SUMMARY

In some embodiments, the disclosure relates to a heat-stabilized polyamide composition comprising (from 25 wt % to 99 wt % % of) an amide polymer, e.g., PA-6,6 or PA-6,6/6T, or combinations thereof, having an amine end group level greater than 50 ueq/gram, e.g., greater than 65 ueq/gram, or from 65 ueq/gram to 105 ueq/gram, e.g., from 65 ueq/gram to 75 ueq/gram; and (from 0 wt % to 65 wt %) filler. The polyamide composition may comprise an additional polyamide. The polyamide composition demonstrates a tensile strength of at least 75 MPa, e.g., at least 100 MPa, or at least 110 MPa, when heat aged for 3000 hours at a temperature of at least 180° C. and measured at 23° C.; and/or when heat aged for 3000 hours over a temperature range of from 190° C. to 220° C., demonstrates a tensile strength retention of greater than 51%, as measured at 23° C.; and/or when heat aged for 2500 hours over a temperature range of from 190° C. to 220° C., the polyamide composition demonstrates a tensile strength retention of greater than 59%, as measured at 23° C.; and/or when heat aged for 3000 hours over a temperature range of from 190° C. to 220° C., the polyamide composition demonstrates a tensile strength of greater than 102 MPa, as measured at 23° C.; and/or when heat aged for 2500 hours over a temperature range of from 190° C. to 220° C., the polyamide composition demonstrates a tensile strength of greater than 119 MPa, as measured at 23° C.; and/or when heat aged for 3000 hours over a temperature range of from 190° C. to 220° C., the polyamide composition demonstrates a tensile modulus of greater than 11110 MPa, as measured at 23° C.; and/or when heat aged for 3000 hours over a temperature range of from 190° C. to 220° C., the polyamide composition demonstrates an impact resilience of greater than 17 KJ/m², as measured at 23° C.; and/or when heat aged for 2500 hours at a temperature of 210° C.; the polyamide composition demonstrates a tensile strength greater than 99 MPa, as measured at 23° C.; and/or when heat aged for 3000 hours at a temperature of 210° C.; the polyamide composition demonstrates a tensile strength greater than 82 MPa, as measured at 23° C.; and/or when heat aged for 2500 hours at a temperature of 210° C.; the polyamide composition demonstrates a tensile strength retention greater than 50%, as measured at 23° C.; and/or wherein, when heat aged for 3000 hours at a temperature of 210° C.; the polyamide composition demonstrates a tensile strength retention greater than 41%, as measured at 23° C.; and/or when heat aged for 2500 hours at a temperature of 210° C.; the polyamide composition demonstrates an impact resilience greater than 17 KJ/m², as measured at 23° C.; and/or when heat aged for 3000 hours at a temperature of 210° C.; the polyamide composition demonstrates an impact resilience greater than 13 KJ/m², as measured at 23° C.; and/or when heat aged for 3000 hours at a temperature of 190° C.; the polyamide composition demonstrates an impact resilience greater than 17 kJ/m², as measured at 23° C. The composition may further comprise a heat stabilizer package that may comprise (from 0.01 wt % to 10 wt % of) a first (lanthanoid-based) heat stabilizer, e.g., a cerium-based heat stabilizer and/or (from 0.01 wt % to 5 wt % of) a second heat stabilizer, e.g., a copper-based compound. The composition may further comprise at least 1 wppm amine/metal complex, e.g., amine/cerium/copper complex, from 1 to 10000 wppm cyclopentanone, and/or (less than 0.3 wt % of) a stearate additive and may have a relative viscosity ranging from 3 to 100. The composition may comprise halide and the weight ratio of the first heat stabilizer to the halide may range from 0.1 to 25. The lanthanoid-based heat stabilizer may comprise a lanthanoid ligand selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates, 2-ethylhexanoates, or combinations thereof. The amide polymer may comprise greater than 90 wt % of a low caprolactam content polyamide, e.g., PA-6,6/6 and/or PA-6,6/6T/6 (or a low melt temperature polyamide), and less than 10 wt % of a non-low caprolactam content polyamide (or a non-low melt temperature polyamide), based on the total weight of the amide polymer. The amide polymer may have an amine end group level greater than 65 ueq/gram; the lanthanoid-based heat stabilizer may comprise cerium oxide and/or cerium oxyhydrate and the polyamide composition may have a cerium content ranging from 10 ppm to 9000 ppm; the second heat stabilizer may comprise a copper based compound; the polyamide composition comprises at least 1 wppm amine/cerium/copper complex. The amide polymer has an amine end group level greater than 65 μeq/gram; the lanthanoid-based heat stabilizer may comprise a cerium-based heat stabilizer; the second heat stabilizer may comprise a copper based compound; the polyamide composition may have a cerium ratio ranging from 5.0 to 50.0; the polyamide composition may comprise at least 1 wppm amine/cerium/copper complex. In some cases, the amide polymer has an amine end group level greater than 65 μeq/gram; the lanthanoid-based compound comprises cerium oxide, cerium oxyhydrate, or cerium hydrate, or combinations thereof and wherein the polyamide composition has a cerium content ranging from 10 ppm to 9000 ppm; the second heat stabilizer comprises a copper-based compound; the polyamide composition comprises at least 1 wppm amine/cerium/copper complex; and when heat aged for 2500 hours over a temperature range of from 190° C. to 220° C., the polyamide composition demonstrates a tensile strength retention of greater than 59%, as measured at 23° C.; and when heat aged for 3000 hours over a temperature range of from 190° C. to 220° C., the polyamide composition demonstrates an impact resilience of greater than 17 KJ/m², as measured at 23° C. In some cases, the amide polymer has an amine end group level greater than 65 ueq/gram; the amide polymer comprises PA-6,6; the composition further comprises an additional polyamide; the lanthanoid-based compound comprises a cerium-based compound; the second heat stabilizer comprises a copper-based compound; and when heat aged for 3000 hours at a temperature of 210° C.; the polyamide composition demonstrates a tensile strength greater than 82 MPa, as measured at 23° C.; and when heat aged for 3000 hours at a temperature of 210° C.; the polyamide composition demonstrates a tensile strength retention greater than 41%, as measured at 23° C.; and when heat aged for 3000 hours at a temperature of 210° C.; the polyamide composition demonstrates an impact resilience greater than 13 KJ/m², as measured at 23° C.

In some embodiments, the disclosure relates to an automotive part comprising the heat-stabilized polyamide composition of claim 1, wherein, when heat aged for 3000 hours at a temperature of 210° C., the automotive part demonstrates an impact resilience greater than 13 kJ/m², as measured at 23° C. In some embodiments, the disclosure relates to an article for use in high temperature applications, wherein the article is formed from the heat-stabilized polyamide composition of claim 1, wherein the article is used for fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts.

### DETAILED DESCRIPTION

This disclosure relates to heat-stabilized polyamide compositions that employ amide polymers having specific levels of amine end groups (AEG), which provide for significant improvements in performance, e.g., tensile strength and/or impact resilience, at higher temperatures and under heat age conditions. Conventional polyamide compositions typically utilize heat stabilizer packages to address high temperature performance. Unfortunately, many of these heat stabilizer packages, standing alone, suffer from stability/performance gaps over broad temperature ranges, e.g., the 190° C. to 220° C. temperature range. As a result, the polyamide structures formed from the compositions are prone to performance and/or structural failures.

The disclosed polyamide compositions and structures take a different approach to address heat stability of polyamides compositions-utilization of particular AEG levels, optionally in combination with specific stabilizer packages. The effective use of these AEG levels contributes to improved heat-aging resilience and may diminish the failure risk of thermally loaded polyamide components. Further, because these AEG levels advantageously provide for improvements in heat age performance, the need for stabilizer packages (to achieve the desired results) can be reduced or eliminated, which leads to process efficiencies, especially in view of the fact that many stabilizer packages contain expensive metal components.

The compositions disclosed herein comprise amide polymers having higher levels of AEGs, which contribute to unexpected high temperature properties. For example, the disclosed polyamide compositions have been found to demonstrate high tensile strength after heat aging. More specifically, the polyamide compositions disclosed herein have been surprisingly found to achieve significant performance improvements at temperatures ranging from 190° C. to 220° C., especially when exposed to heat aging at such temperatures for prolonged periods of time. Importantly, this temperature range is where many polyamide structures are utilized, for example in automotive applications. Exemplary automotive applications may include a variety of “under-the-hood” uses, such as cooling systems for internal combustion engines. In particular, many polyamide structures are employed in turbo chargers and charge air cooler systems, which expose the polyamide to high temperatures.

Without being bound by theory, it is believed that the specific AEG levels promote accelerated branching (or perhaps crosslinking) of the polyamide, especially at higher temperatures. This branching leads to an increase in molecular weight, which is believed to reduce temperature degradation in terms of mechanical properties. It is postulated that the increase in molecular weight reduces the rate of degradation, e.g., at higher temperatures, so the degradation does not happen as fast.

Also, the inventors have found that by utilizing the aforementioned AEG levels, certain detrimental reaction byproducts may be reduced or eliminated. The reduction or elimination of these byproducts has unexpectedly been found to have advantageous effects on degradation performance. In particular, it has been found that cyclopentanone may form during the thermos-oxidative degradation process, and the cyclopentanone contributes to polymer degradation, in particular at temperatures ranging from 190° C. to 220° C. It is believed that cyclopentanone may be formed via a cyclization mechanism that is promoted by acid end groups on the polymers. These acid end groups react to cyclize and form detrimental cyclopentanone. The inventors have found that by employing the AEG levels disclosed herein, the kinetics of the amine end group/acid end group interactions are beneficially balanced. And this improvement leads to fewer acid end group-promoted cyclization, which leads to less cyclopentanone being produced. As a result of the reduced amounts of cyclopentanone, degradation performance is improved, especially in the temperature gap from 190° C. to 220° C.

Further, it is believed that the AEGs of the amide polymers may react and/or complex synergistically with the components of particular heat stabilizers, e.g., lanthanoid- or copper-based heat stabilizers, thus resulting in an amide polymer/metal complex. This complex may stabilize the oxidation state of these metals, which may contribute to significant improvements in heat age performance. In some cases, it is postulated that the complexing beneficially alters the ligand(s) that are present in the heat stabilizers.

In some embodiments, the disclosure relates to a heat-stabilized polyamide composition comprising (from 25 wt % to 90 wt % of) an amide polymer having a high AEG level (for example a AEG level greater than 50 μeq/gram). As a result, the polyamide composition demonstrates, among other characteristics, a high tensile strength, e.g., at least (greater than) 75 MPa, when heat aged for 3000 hours at a temperature of at least 180° C. and measured at 23° C.; and/or greater than 102 MPa, when heat aged for 3000 hours over an entire temperature range of from 190° C. to 220° C. and measured at 23° C. In contrast, conventional polyamide compositions that utilize conventional lower AEG levels demonstrate inferior tensile strength values, especially over the aforementioned entire temperature ranges.

In some embodiments, the polyamide composition further comprises a heat stabilizer package, which may comprise a first stabilizer, for example (from 0.01 wt % to 10 wt % of) a lanthanoid-based compound and/or a second heat stabilizer (other than the first (lanthanoid-based) heat stabilizer). The heat stabilizers may be metal-based heat stabilizer(s), e.g., lanthanoid-based compounds and/or copper-based compounds.

### End Groups

As used herein, amine end groups are defined as the quantity of amine ends (—NH2) present in a polyamide. AEG calculation methods are well known.

The disclosed amide polymers utilize particular ranges and/or limits of AEG levels. In some embodiments, the amide polymer has an AEG level ranging from 50 μeq/gram to 90 ueq/gram, e.g., from 55 ueq/gram to 85 ueq/gram, from 60 ueq/gram to 90 ucq/gram, from 70 ucq/gram to 90 ueq/gram from 74 ueq/gram to 89 ueq/gram, from 76 ueq/gram to 87 ueq/gram, 78 μeq/gram to 85 ueq/gram, from 60 ueq/gram to 80 μeq/gram, from 62 ueq/gram to 78 ueq/gram, from 65 μeq/gram to 75 ueq/gram, or from 67 ueq/gram to 73.

In terms of lower limits, the base polyamide composition may have an AEG level greater than 50 ueq/gram, e.g., greater than 55 ueq/gram, greater than 57 ueq/gram, greater than 60 ueq/gram, greater than 62 ueq/gram, greater than 65 ueq/gram, greater than 67 ueq/gram, greater than 70 μeq/gram, greater than 72 ueq/gram, greater than 74 ueq/gram, greater than 75 ucq/gram, greater than 76 ueq/gram or greater than 78 μeq/gram. In terms of upper limits, the base polyamide composition may have an AEG level less than 90 μeq/gram, e.g. less than 89 μeq/gram, less than 87 ueq/gram, less than 85 μeq/gram, less than 80 ueq/gram, less than 78 ueq/gram, less than 75 ueq/gram, less than 70 μeq/gram, less than 65 ueq/gram, less than 63 ueq/gram, or less than 60 ueq/gram. Again, the utilization of the specific AEG levels provides for the unexpected combination of heat age resilience, e.g., tensile strength and/or impact resilience (among others).

The AEG content may be obtained/achieved/controlled by treating a conventional lower AEG content polyamide, non-limiting examples of which are provided below. In some cases, AEG level may be obtained/achieved/controlled by controlling the amount of excess hexamethylene diamine (HMD) in the polymerization reaction mixture. HMD is believed to be more volatile than the (di) carboxylic acids that are employed in the reaction, e.g. adipic acid. Generally, the excess HMD in the reaction mixture ultimately affects the level of the AEGs. In some cases, the AEG level may be obtained/achieved/controlled via the incorporation of (mono) amines, e.g., by “capping” some of the end structures with amines, and the monofunctional end capping may be employed to arrive at the aforementioned high AEG level amide polymers.

Exemplary (mono) amines include but are not limited to benzylamine, ethylamine, propylamine, butylamine, pentylamine, hexylamine, 2-ethyl-1-hexylamine, heptylamine, octylamine, nonylamine, decylamine, undecylamine, dodecylamine, amylamine, tert-butyl amine, tetradecylamine, hexadecylamine, or octadecylamine, or any combinations thereof. Exemplary (mono) acids include but are not limited to acetic acid, proprionic acid, butyric acid, valeric acid, hexanoic acid, octanoic acid, palmitic acid, myristic acid, decanoic acid, undecanoic acid, dodecanoic acid, oleic acid, or stearic acid, or any combinations thereof.

### Polyamide

As noted above, the disclosed heat-stabilized polyamide compositions comprise an amide polymer having a high amounts of AEG (high AEG polyamides). The polyamide itself, e.g., the base polyamide that may be treated to form the high AEG polyamide) may vary widely. In some cases, a polyamide may be processed to achieve the high AEG content (exemplary techniques are noted above).

Many varieties of natural and artificial polyamides are known and may be utilized in the formation of the high AEG polyamide. Common polyamides include nylons and aramids. For example, the polyamide may comprise PA-4T/41; PA-4T/61; PA-5T/5I; PA-6; PA-6,6; PA-6,6/6; PA-6,6/6T; PA-6T/6I; PA-6T/61/6; PA-6T/6; PA-6T/61/66; PA-6T/MPDMT (where MPDMT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/61/6; PA-6T/61/12; and combinations thereof.

The amide polymer of the composition can include aliphatic polyamides such as polymeric E-caprolactam (PA6) and polyhexamethylene adipamide (PA66) or other aliphatic nylons, polyamides with aromatic components such as paraphenylenediamine and terephthalic acid, and copolymers such as adipate with 2-methyl pentmethylene diamine and 3,5-diacarboxybenzenesulfonic acid or sulfoisophthalic acid in the form of its sodium sultanate salt. The polyamides can include polyaminoundecanoic acid and polymers of bis-paraaminocyclohexyl methane and undecanoic acid. Other polyamides include poly(aminododecanoamide), polyhexamethylene sebacamide, poly(p-xylylencazeleamide), poly(m-xylylene adipamide), and polyamides from bis(p-aminocyclohexyl) methane and azelaic, sebacic and homologous aliphatic dicarboxylic acids. As used herein, the terms “PA6 polymer” and “PA6 polyamide polymer” also include copolymers in which PA6 is the major component. As used herein the terms “PA66 polymer” and “PA66 polyamide polymer” also include copolymers in which PA66 is the major component. In some embodiments, copolymers such as PA-6,6/61; PA-61/6T; or PA-6,6/6T, or combinations thereof are contemplated for use as the polyamide polymer. In some cases, physical blends, e.g., melt blends, of these polymers are contemplated. In one embodiment, the polyamide polymer comprises PA-6, or PA-6,6, or a combination thereof.

The high AEG polyamide of the heat-stabilized polyamide compositions may comprise a combination of polyamides. By combining various polyamides, the final composition may be able to incorporate the desirable properties, e.g., mechanical properties, of each constituent polyamides.

In some cases, the high AEG polyamide, e.g., the high AEG PA-6,6 and/or PA-6,6/6T, may be present in the composition in an amount from 20 wt % to 99 wt %, from 30 wt % to 85 wt %, from 30 wt % to 70 wt %, from 40 wt % to 60 wt %, from 50 wt % to 90 wt %, from 70 wt % to 90 wt %, and from 80 wt % to 90 wt %. In terms of upper limits, these polyamides may be present in an amount less than 99 wt %, e.g., less than 90 wt %, less than 80 wt %, less than 70 wt %, less than 60 wt %, less than 50 wt %, less than 30 wt %, less than 20 wt %, or less than 15 wt %. In terms lower limits, these polyamides may be present in an amount greater than 1 wt %, e.g., greater than 10 wt %, greater than 20 wt %, greater than 30 wt %, greater than 40 wt %, greater than 50 wt %, great than 70 wt %, and greater than 80 wt %.

In some cases, the polyamide compositions may further comprise additional polyamides, which may have low AEG content, in addition to the high AEG polyamides. Stated another way, the compositions may comprise both high AEG polyamides and low AEG polyamides. The low AEG polyamides may include any of the aforementioned polyamides that do not have or have not been treated to have the high AEG content described herein. The combination of polyamides in the compositions may comprise any number of known polyamides. For example, in some embodiments, the polyamide comprises a combination of (low AEG) polyamide with (high AEG) PA-6,6, and/or (high AEG) PA-6,6/6T. In some embodiments, the composition comprises (low AEG) polyamide and (high AEG) PA-6,6/6T. In some embodiments, the composition comprises (low AEG) polyamide and (high AEG) PA-6,6.

The heat-stabilized polyamide composition may comprise from 25 wt % to 99 wt % of polymer (as a whole-high AEG polyamide and low AEG polyamide), based on the total weight of the heat-stabilized polyamide composition. In some cases, the heat-stabilized polyamide composition may comprise amide polymer in an amount from 25 wt % to 99 wt %, from 30 wt % to 95 wt %, from 30 wt % to 85 wt %, from 50 wt % to 95 wt %, from 50 wt % to 90 wt %, from 50 wt % to 75 wt %, from 55 wt % to 70 wt %, from 57 wt % to 67 wt %, from 59 wt % to 65 wt %, from 70 wt % to 95 wt %, from 70 wt % to 90 wt %, and from 80 wt % to 95 wt %., or from 80 wt % to 90 wt %. In terms of upper limits, the heat-stabilized polyamide composition may comprise amide polymer in an amount less than 99 wt %, e.g., less than 95 wt %, less than 90 wt %, less than 75 wt %, less than 70 wt %, less than 67 wt %, or less than 65 wt %. In terms of lower limits, the heat-stabilized polyamide composition may comprise amide polymer in an amount greater than 25 wt %, e.g. greater than 30 wt %, greater than 50 wt %, greater than 55 wt %, greater than 57 wt %, greater than 59 wt %, greater than 59 wt % greater than 70 wt %, greater than 80 wt %, greater than 85 wt %, or greater than 90 wt %.

The low AEG polyamides, in some cases, may include those produced through the ring-opening polymerization or polycondensation, including the copolymerization and/or copolycondensation, of lactams. These polyamides can include, for example, those produced from propriolactam, butyrolactam, valerolactam, and caprolactam. For example, in some embodiments, the composition includes a polyamide polymer derived from the polymerization of caprolactam. The low AEG polyamide may also comprise caprolactam-containing polymers and copolymers. For example the low AEG polyamide may comprise polyamides can include, for example, those produced from propriolactam, butyrolactam, valerolactam, and caprolactam, e.g., PA-66/6; PA-6; PA-66/6T; PA-6/66; PA-6T/6; PA-6,6/61/6; PA-61/6; or 6T/61/6, or combinations thereof. In some cases, these copolymers may have low caprolactam content, e.g., below 50%, or combinations thereof.

For example, in some embodiments, e.g., wherein the low AEG polyamide is a caprolactam polymer, the low AEG polyamide, e.g., the caprolactam polyamide, is present in an amount greater than 1 wt % of the total polymer, e.g., greater than 2 wt %, greater than 4 wt %, greater than 5 wt %, greater than 10 wt %, greater than 11 wt %, greater than 15 wt %, greater than 20 wt %, or greater than 25 wt %. In terms of ranges, the composition comprises from 2 wt % to 50 wt % low AEG polyamide, e.g., from 2 wt % to 40 wt %, from 2 wt % to 20 wt %, from 4 wt % to 30 wt %, from 4 wt % to 20 wt %, from 1 wt % to 15 wt %, from 1 wt % to 10 wt % from 2 wt % to 8 wt %, from 10 wt % to 50 wt %, from 15 wt % to 47 wt %, from 20 wt % to 47 wt %, from 25 wt % to 45 wt %, or from 30 wt % to 45 wt %. In terms of upper limits, the composition comprises less than 50 wt % low AEG polyamide, e.g., less than 47 wt %, less than 45 wt %, less than 42 wt %, less than 40 wt %, less than 35 wt %, less than 30 wt %, less than 20 wt %, less than 15 wt %, less than 10 wt %, or less than 8 wt %. These ranges are applicable to low AEG polyamides, e.g., caprolactam-based polyamides, individually as well.

In particular, when PA-66/6; PA-6; PA-66/6T; PA-6/66; PA-6T/6; PA-6,6/61/6; PA-61/6; or 6T/61/6, or combinations thereof are employed, these may be present in an amount from 1 wt % to 80 wt %, from 5 wt % to 70 wt %, from 10 wt % to 50 wt %, 2 wt % to 40 wt %, from 2 wt % to 20 wt %, from 4 wt % to 30 wt %, from 4 wt % to 20 wt %, from 1 wt % to 15 wt %, from 1 wt % to 10 wt % from 2 wt % to 8 wt %, from 10 wt % to 30 wt %, or from 10 wt % to 20 wt %. In terms of upper limits, these may be present in an amount less than 99 wt %, e.g., less than 90 wt %, less than 80 wt %, less than 70 wt %, less than 50 wt %, less than 40 wt %, less than 30 wt %, less than 20 wt %, less than 15 wt %, less than 10 wt %, or less than 8 wt %. In terms of lower limits, these may be present in an amount greater than 1 wt %, e.g., greater than 2 wt %, greater than 4 wt %, greater than 5 wt %, greater than 10 wt %, greater than 11 wt %, or greater than 12 wt %. In some cases, these are present in amounts significantly lower than the amount of other polyamide.

In addition, the inventors have found that the use of particular (greater) quantities of (high AEG), low caprolactam content polyamide, e.g., PA-6,6/6 copolymer, e.g., greater than 90 wt %, (and thus lower amount of higher caprolactam content polyamides, e.g., PA-6) surprisingly provides for better heat stability over the aforementioned temperature ranges, especially when employed along with the synergistic heat stabilizer packages. Also, it has unexpectedly been found that the use of particular (greater) quantities of polyamides having low melt temperatures, e.g., below 210° C., (and thus lower amounts of higher melt temperature polyamides, e.g., PA-6) actually improves heat stability. Traditionally, it has been believed that the use of low caprolactam content polyamides and/or low melt temperature polyamides would be detrimental to the ultimate high temperature performance of the resultant polymer composition, e.g., since these low temperature polyamides have lower melt temperatures than high caprolactam content polyamides. The inventors have unexpectedly found that the addition of certain quantities of low caprolactam content (and in some cases, high AEG content) polyamides and/or low melt temperature polyamides actually improves high temperature heat performance. Without being bound by theory, it is postulated that, at higher temperatures, these amide polymers actually “unzip” and shift toward the monomer phase, which surprisingly leads to the high heat performance improvements. Further, it is believed that the use of the polyamides having low melt temperatures actually provides for a reduction of the temperature at which the unzipping occurs, thus unexpectedly further contributing to improved thermal stability.

In some embodiments, as noted herein, a low caprolactam content polyamide is utilized, e.g., a polyamide comprising less than 50 wt % caprolactam, e.g., less than 49 wt %, less than 48 wt %, less than 47 wt %, less than 46 wt %, less than 45 wt %, less than 44 wt %, less than 42 wt %, less than 40 wt %, less than 37 wt %, less than 35 wt %, less than 33 wt %, less than 30 wt %, less than 28 wt %, less than 25 wt %, less than 23 wt %, or less than 20 wt %. In terms of ranges, the low caprolactam content polyamide may comprise from 5 wt % to 50 wt % caprolactam, e.g., from 10 wt % to 49.9 wt %, from 15 wt % to 49.5 wt %, from 20 wt % to 49.5 wt %, from 25 wt % to 48 wt %, from 30 wt % to 48 wt %, from 35 wt % to 48 wt %, from 37 wt % to 47 wt %, from 39 wt % to 46 wt %, from 40 wt % to 45 wt %, from 41 wt % to 45 wt %, from 41 wt % to 44 wt %, or from 41 wt % to 43 wt %. In terms of lower limits, the low caprolactam content polyamide may comprise greater than 2 wt % caprolactam, e.g., greater than 5 wt %, greater than 10 wt %, greater than 15 wt %, greater than 20 wt %, greater than 25 wt %, greater than 30 wt %, greater than 35 wt %, greater than 37 wt %, greater than 39 wt %, greater than 40 wt %, or greater than 41 wt %. Examples of low caprolactam content polyamides include PA-66/6; PA-6; PA-66/6T; PA-6/66; PA-6T/6; PA-6,6/61/6; PA-61/6; or 6T/61/6, or combinations thereof. These polyamides may contain some caprolactam, but it may be in low amounts.

In some embodiments, a low melt temperature polyamide is utilized, e.g., a polyamide having a melt temperature below 210° C., e.g., below 208° C., below 205° C., below 203° C., below 200° C., below 198° C., below 195° C., below 193° C., below 190° C., below 188° C., below 185° C., below 183° C., below 180° C., below 178° C., or below 175° C. Some polyamides may be low caprolactam content polyamides as well as low melt temperature polyamides, e.g., PA-66/6. In other cases, low melt temperature polyamides may not include some low caprolactam content polyamides, and vice versa.

In some embodiments, the low caprolactam content polyamide comprises PA-6,6/6; PA-6T/6; PA-6,6/6T/6; PA-6,6/61/6; PA-6,6; PA-61/6; or 6T/61/6, or combinations thereof. In some cases, the low caprolactam content polyamide comprises PA-6,6/6 and/or PA-6,6/6T/6. In some embodiments, the low caprolactam content polyamide comprises PA-6,6/6 and/or PA-6,6.

In some embodiments, the low melt temperature polyamide comprises PA-6,6/6; PA-6T/6; PA-6,6/61/6; PA-61/6; or 6T/61/6, or combinations thereof. In some cases, the low caprolactam content polyamide comprises PA-6,6/6. In some cases, the melt temperature of the low melt temperature polyamide may be controlled by manipulating the monomer components.

In some cases, the polyamide includes particular (high) concentrations of (high AEG content) low caprolactam content polyamide (including polyamides that comprise no caprolactam) and/or low melt temperature polyamide. For example, the polyamide may comprise greater than 90 wt % of low caprolactam content polyamide and/or low melt temperature polyamide, e.g., greater than 91 wt %, greater than 92 wt %, greater than 93 wt %, greater than 94 wt %, greater than 95 wt %, greater than 96 wt %, greater than 97 wt %, greater than 98 wt %, greater than 99 wt %, or greater than 99.5 wt %. In terms of ranges, the polyamide may comprise from 90 wt % to 100 wt % low caprolactam content polyamide and/or low melt temperature polyamide, e.g., from 90 wt % to 99 wt %, from 90 wt % to 98 wt %, from 90 wt % to 96 wt %, from 91 wt % to 99 wt %, from 91 wt % to 98 wt %, from 91 wt % to 97 wt %, from 91 wt % to 96 wt %, from 92 wt % to 98 wt %, from 92 wt % to 97 wt %, or from 92 wt % to 96 wt %. In terms of upper limits, the polyamide may comprise less than 100 wt % low caprolactam content polyamide and/or low melt temperature polyamide, e.g., less than 99 wt %, less than 98 wt %, less than 97 wt %, less than 96 wt %, less than 95 wt %, less than 94 wt %, less than 93 wt %, less than 92 wt %, or less than 91 wt %.

In some cases, the polyamide includes particular (low) concentrations of other non-low caprolactam content and/or high melt temperature polyamides. For example, the polyamide may comprise less than 10 wt % of non-low caprolactam content polyamide and/or low melt temperature polyamide, e.g., less than 9 wt %, less than 8 wt %, less than 7 wt %, less than 6 wt %, less than 5 wt %, less than 4 wt %, less than 3 wt %, less than 2 wt % or less than 1 wt %. In terms of ranges, the polyamide may comprise from 0.5 wt % to 10 wt % other non-low caprolactam content and/or high melt temperature polyamides, e.g., from 1 wt % to 9 wt %, from 1 wt % to 8 wt %, from 2 wt % to 8 wt %, from 3 wt % to 8 wt %, from 3 wt % to 7 wt %, from 4 wt % to 9 wt %, from 4 wt % to 8 wt %, from 5 wt % to 9 wt %, from 5 wt % to 8 wt %, or from 6 wt % to 8 wt %. In terms of lower limits, the polyamide may comprise greater than 0.5 wt % of non-low caprolactam content polyamide and/or low melt temperature polyamide, e.g., greater than 1 wt %, greater than 2 wt %, greater than 3 wt %, greater than 4 wt %, greater than 5 wt %, greater than 6 wt %, greater than 7 wt %, greater than 8 wt %, or greater than 9 wt %.

Furthermore, the heat-stabilized polyamide compositions may comprise the polyamides produced through the copolymerization of a lactam with a nylon, for example, the product of the copolymerization of a caprolactam polyamide with PA-6,6.

In addition to the compositional make-up of the polyamide composition, it has also been discovered that the relative viscosity of the amide polymer in combination with the stabilizer package has been found to have many surprising benefits, both in performance and processing. For example, if the relative viscosity of the amide polymer is within certain ranges and/or limits, production rates and tensile strength (and optionally impact resilience) are improved.

In the heat-stabilized polyamide compositions, the amide polymer may have a relative viscosity ranging from 3 to 100, e.g. from 10 to 80, from 20 to 75, from 30 to 60, from 35 to 55, from 40 to 50, or from 42 to 48. In terms of lower limits, the relative viscosity of the amide polymer may be greater than 3, e.g., greater than 10, greater than 20, greater than 30, greater than 35, greater than 36, greater than 40, or greater than 42. In terms of upper limits, the relative viscosity of the amide polymer may be less than 100, e.g., less than 80, less than 75, less than 60, less than 55, less than 50, or less than 48. Relative viscosity may be determined via the formic acid method.

In some cases, the heat-stabilized polyamide composition (in some cases after or during heat aging) comprises low amounts of cyclopentanone, which improves degradation performance as noted above. In some embodiments, the heat-stabilized polyamide composition comprises from 1 ppm to 1 wt % (10,000 ppm) cyclopentanone, e.g., from 1 ppm to 5000 ppm, from 10 ppm to 4500 ppm, from 50 ppm to 4000 ppm, from 100 ppm to 4000 ppm, from 500 ppm to 4000 ppm, from 1000 ppm to 5000 ppm, from 2000 ppm to 4000 ppm, from 1500 ppm to 4500 ppm, from 1000 ppm to 3000 ppm, from 1500 ppm to 2500 ppm, or from 2500 ppm to 3500 ppm. In terms of lower limits, the heat-stabilized polyamide composition may comprise greater than 1 ppm cyclopentanone, e.g. greater than 10 ppm, greater than 50 ppm, greater than 100 ppm, greater than 250 ppm, greater than 400 ppm, greater than 500 ppm, greater than 1000 ppm, greater than 1500 ppm, greater than 2000 ppm, or greater than 2500 ppm. In terms of upper limits, the heat-stabilized polyamide composition may comprise less than 10,000 ppm cyclopentanone, e.g., less than 5000 ppm, less than 4500 ppm, less than 4000 ppm, less than 3500 ppm, less than 3000 ppm, less than 2500 ppm, less than 2000 ppm, less than 1500 ppm, or less than 1000 ppm.

### Heat Stabilizer Packages

The heat stabilizer packages disclosed herein may, in combination with the AEG levels, synergistically improve the utility and functionality of polyamide compositions by mitigating, retarding, or preventing the effects damage, e.g., thermooxidative damage, that result from exposure of polyamides to heat. The heat stabilizer packages may vary widely and many polymer (polyamide) heat stabilizers are known and commercially available.

In some embodiments, the heat stabilizer package comprises a first heat stabilizer, e.g., a lanthanoid-based compound and/or a second heat stabilizer. In some cases, the amount of the first heat stabilizer is present in an amount greater than the second heat stabilizer.

### Lanthanoids

The first heat stabilizer may vary widely. Generally, the first heat stabilizer is a compound that comprises a lanthanoid, e.g., cerium or lanthanum. In some embodiments, the lanthanoid may be lanthanum, cerium, pracsodymium, neodymium, promethium, samarium, curopium, gadolinium, terbium, dysprosium, holmium, erbium, thulium, yuerbium, or lutetium, or combinations thereof. In some cases, the lanthanoids-based heat stabilizer may have has an oxidation number of +III or +IV.

In some cases, the first heat stabilizer is generally of the structure (L) Xn, where X is a ligand and n is a non-zero integer, and L is the lanthanoid. That is to say, in some embodiments, the lanthanoid-based heat stabilizer is a lanthanoid-based ligand. The inventors have found that particular lanthanoid ligands are able to stabilize polyamides particularly well, especially when utilized in the aforementioned amounts, limits, and/or ratios. In some embodiments, the ligand(s) may be selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates, 2-ethylhexanoates, or combinations thereof. Hydrates of these are contemplated as well.

In some cases, the ligand may be an oxide and/or an oxyhydrate. In some embodiments, the heat stabilizer comprises specific oxide/oxyhydrate compounds, preferably lanthanoid (cerium) oxide and/or lanthanoid (cerium) oxyhydrate. In some cases, cerium oxyhydrate and cerium oxide may have a CAS number of 1306-38-3; cerium hydrate may have a CAS number of 12014-56-1.

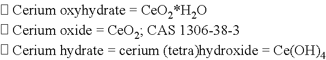

In some cases, lanthanum is the lanthanoid metal. The aforementioned ligands are applicable. In some embodiments, the lanthanoid-based compound comprises lanthanum-based compounds, e.g., lanthanum oxide, or lanthanum oxyhydrate, or combinations thereof. Lanthanum hydrate is also an option. In some embodiments, the heat-stabilized polyamide compositions comprise multiple lanthanoid-based heat stabilizers. For example, the heat-stabilized polyamide composition may comprise both lanthanum oxide, lanthanum (tri) hydroxide (hydrate), lanthanum oxyhydrate and/or lanthanum acetate. In some cases, the first stabilizer comprises combinations of lanthanum-based compounds and cerium-based compounds are.

In some embodiments, the heat-stabilized polyamide compositions comprise multiple lanthanoid-based heat stabilizers. For example, the heat-stabilized polyamide composition may comprise both cerium oxyhydrate and cerium acetate. By selecting multiple cerium-based heat stabilizers, one may be able to synergistically improve the heat stabilization effect of the individual heat stabilizer. Furthermore, a polyamide composition comprising multiple cerium-based heat stabilizers may provide improved heat stability over a broader range of temperatures or at higher temperatures. In some preferred embodiments, when cerium is the lanthanoid, the cerium-based compound may comprise a cerium oxyhydrate, cerium acetate, or combination thereof.

The inventors have found that, surprisingly, employing a cerium-based compound that comprises both cerium hydrate and cerium acetate results in a heat stabilizer package that provides for the benefits discussed herein.

In some embodiments, the polyamide composition comprises the first heat stabilizer, e.g., the lanthanoid-based compound, e.g., cerium/lanthanum oxide and/or cerium/lanthanum oxyhydrate, in an amount ranging from 0.01 wt % to 10.0 wt %, e.g., from 0.01 wt % to 8.0 wt %, from 0.01 wt % to 7.0 wt %, from 0.02 wt % to 5.0 wt %, from 0.03 to 4.5 wt %, from 0.05 wt % to 4.5 wt %, from 0.07 wt % to 4.0 wt %, from 0.07 wt % to 3.0 wt %, from 0.1 wt % to 3.0 wt %, from 0.1 wt % to 2.0 wt %, from 0.2 wt % to 1.5 wt %, from 0.1 wt % to 1.0 wt %, or from 0.3 wt % to 1.2 wt %. In terms of lower limits, the polyamide composition may comprise greater than 0.01 wt % first heat stabilizer, e.g., greater than 0.02 wt %, greater than 0.03 wt %, greater than 0.05 wt %, greater than 0.07 wt %, greater than 0.1 wt %, greater than 0.2 wt %, or greater than 0.3 wt %. In terms of upper limits, the polyamide composition may comprise less than 10.0 wt % first heat stabilizer, e.g., less than 8.0 wt %, less than 7.0 wt %, less than 5.0 wt %, less than 4.5 wt %, less than 4.0 wt %, less than 3.0 wt %, less than 2.0 wt %, less than 1.5 wt %, less than 1.2 wt %, less than 1.0 wt %, or less than 0.7 wt %.

In some embodiments, the polyamide composition comprises less than 1.0 wt % of cerium dioxide, e.g., less than 0.7 wt %, less than 0.5 wt %, less than 0.3 wt %, less than 0.1 wt %, less than 0.05 wt %, or less than 0.01 wt %. In terms of ranges, the polyamide composition may comprise from 1 wppm to 1 wt % of cerium dioxide, e.g., from 1 wppm to 0.5 wt %, from 1 wppm to 0.1 wt %, from 5 wppm to 0.05 wt %, or from 5 wppm to 0.01 wt %.

In some cases, the polyamide composition comprises little or no cerium hydrate, e.g., less than 10.0 wt % cerium hydrate, e.g., less than 8.0 wt %, less than 7.0 wt %, less than 5.0 wt %, less than 4.5 wt %, less than 4.0 wt %, less than 3.0 wt %, less than 2.0 wt %, less than 1.5 wt %, less than 1.2 wt %, less than 1.0 wt %, less than 0.7 wt %, less than 0.5 wt %, less than 0.3 wt %, or less than 0.1 wt %. In some cases, the polyamide composition comprises substantially no cerium hydrate, e.g., no cerium hydrate.

The ranges and limits mentioned are applicable to the lanthanoid-based compounds generally, as well as to the cerium-based compounds and lanthanum-based compounds specifically.

In some embodiments, the polyamide composition comprises cerium (or lanthanum) oxide (optionally as the only cerium-based heat stabilizer), or cerium (or lanthanum) oxyhydrate (optionally as the only cerium-based heat stabilizer), or a combination of cerium (or lanthanum) oxide and cerium (or lanthanum) oxyhydrate in an amount ranging from 10 ppm to 1 wt %, e.g., from 10 ppm to 9000 ppm, from 20 ppm to 8000 ppm, from 50 ppm to 7500 ppm, from 500 ppm to 7500 ppm, from 1000 ppm to 7500 ppm, from 2000 ppm to 8000 ppm, from 1000 ppm to 9000 ppm, from 1000 ppm to 8000 ppm, from 2000 ppm to 8000 ppm, from 2000 ppm to 7000 ppm, from 2000 ppm to 6000 ppm, from 2500 ppm to 7500 ppm, from 3000 ppm to 7000 ppm, from 3500 ppm to 6500 ppm, from 4000 ppm to 6000 ppm, or from 4500 ppm to 5500 ppm.

In terms of lower limits, the polyamide composition may comprise greater than 10 ppm cerium (or lanthanum) oxide, or cerium (or lanthanum) oxyhydrate, or a combination thereof, e.g., greater than 20 ppm, greater than 50 ppm, greater than 100 ppm, greater than 200 ppm, greater than 500 ppm, greater than 1000 ppm, greater than 2000 ppm, greater than 2500 ppm, greater than 3000 ppm, greater than 3200 ppm, greater than 3300 ppm, greater than 3500 ppm, greater than 4000 ppm, or greater than 4500 ppm. In terms of upper limits, the polyamide composition may comprise less than 1 wt % cerium oxide, or cerium oxyhydrate, or a combination thereof, e.g., less than 9000 ppm, less than 8000 ppm, less than 7500, less than 7000 ppm, less than 6500 ppm, less than 6000 ppm, or less than 5500 ppm.

In some embodiments, where cerium oxide, or cerium oxyhydrate, or a combination of cerium oxide and cerium oxyhydrate is utilized, the polyamide comprises cerium (not including ligand) in an amount ranging from 10 ppm to 9000 ppm, e.g., from 20 ppm to 7000 ppm, from 50 ppm to 7000 ppm, from 50 ppm to 6000 ppm, from 50 ppm to 5000 ppm, from 100 ppm to 6000 ppm, from 100 ppm to 5000 ppm, from 200 ppm to 4500 ppm, from 500 ppm to 5000 ppm, from 1000 ppm to 5000 ppm, from 1000 ppm to 4000 ppm, from 1000 ppm to 3000 ppm, from 1500 ppm to 4500 ppm, from 2000 ppm to 5000 ppm, from 2000 ppm to 4500 ppm, from 2000 ppm to 3000 ppm, from 1500 ppm to 2500 ppm, from 2000 ppm to 4000 ppm, from 2500 ppm to 3500 ppm, from 2700 ppm to 3300 ppm, or from 2800 ppm to 3200 ppm. In some embodiments, when lanthanum is the lanthanoid metal, similar concentration ranges and limits apply.

In terms of lower limits, the polyamide composition comprises cerium (not including ligand) in an amount greater than 10 ppm, e.g., greater than 20 wppm, greater than 50 wppm, greater than 100 wppm, greater than 200 wppm, greater than 500 wppm, greater than 1000 wppm, greater than 1500 wppm, greater than 2000 wppm, greater than 2500 wppm, greater than 2700 wppm, or greater than 2800 wppm. In terms of upper limits, the polyamide composition comprises cerium (not including ligand) in an amount less than 9000 ppm, e.g., less than 7000 ppm, less than 6000 ppm, less than 5000 ppm, less than 4500 ppm, less than 4000 ppm, less than 3500 ppm, less than 3300 ppm, less than 3200 ppm, less than 3000 ppm, less than 2700 ppm, less than 2500 ppm, or less than 2200 ppm. In some embodiments, when lanthanum is the lanthanoid metal, similar concentration ranges and limits apply.

### Second Heat Stabilizer

The second heat stabilizer may vary widely. The inventors have found that particular second heat stabilizers unexpectedly provide for synergistic results, especially when utilized in the aforementioned amounts, limits, and/or ratios and with the lanthanoid-based stabilizer, stearate additive, and halide additive.

In some embodiments, the second heat stabilizer may be selected from the group consisting of phenolics, amines, polyols, and combinations thereof.

For example, the heat stabilizer package may comprise amine stabilizers, e.g., secondary aromatic amines. Examples include adducts of phenylene diamine with acetone (Naugard A), adducts of phenylene diamine with linolene, Naugard 445, N,N′-dinaphthyl-p-phenylene diamine, N-phenyl-N′-cyclohexyl-p-phenylene diamine, N,N′-diphenyl-p-phenylene diamine or mixtures of two or more thereof.

Other examples include heat stabilizers based on sterically hindered phenols. Examples include N,N′-hexamethylene-bis-3-(3,5-di-tert-butyl-4-hydroxyphenyl)-propionamide, bis-(3,3-bis-(4′-hydroxy-3′-tert-butylphenyl)-butanoic acid)-glycol ester, 2,1′-thioethylbis-(3-(3,5-di-tert-butyl-4-hydroxyphenyl)-propionate, 4-4′-butylidene-bis-(3-methyl-6-tert-butylphenol), triethyleneglycol-3-(3-tert-butyl-4-hydroxy-5-methylphenyl)-propionate or mixtures these stabilisers.

Further examples include phosphites and/or phosphonites. Specific examples include phosphites and phosphonites are triphenylphosphite, diphenylalkylphosphite, phenyldialkylphosphite, tris(nonylphenyl) phosphite, trilaurylphosphite, trioctadecylphosphite, distearylpentaerythritoldiphosphite, tris(2,4-di-tert-butylphenyl) phosphite, diisodecylpentaerythritoldiphosphite, bis(2,4-di-tert-butylphenyl) pentaerythritoldiphosphite, bis(2,6-di-tert-butyl-4-methylphenyl) pentaerythritoldiphosphite, diisodecyloxypentaerythritoldiphosphite, bis(2,4-di-tert-butyl-6-methylphenyl) pentacrythritoldiphosphite, bis(2,4,6-tris-(tert-butylphenyl) pentacrythritoldiphosphite, tristearylsorbitoltriphosphite, tetrakis(2,4-di-tert-butylphenyl)-4,4′-biphenylenediphosphonite, 6-isooctyloxy-2,4,8,10-tetra-tert-butyl-12H-dibenzo-[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl)methylphosphite and bis(2,4-di-tert-butyl-6-methylphenyl)ethylphosphite. Particularly preferred are tris[2-tert-butyl-4-thio(2′-methyl-4′-hydroxy-5′-tert-butyl)-phenyl-5-methyl]phenylphosphite and tris(2,4-di-tert-butylphenyl)phosphite (Hostanox® PAR24: commercial product of the company Clariant, Basel).

In some embodiments, the second heat stabilizer comprises a copper-based stabilizer. The inventors have surprisingly found that the use of the copper-based stabilizer and the cerium-based stabilizer in the amounts discussed herein has a synergistic effect. Without being bound by theory, it is believed that the combination of the activation temperatures of the cerium-based heat stabilizer and the copper-based stabilizer unexpectedly provide for thermooxidative stabilization at particularly useful ranges, e.g., 190° C. to 220° C. or 190° C. to 210° C. This particular range has been shown to present a performance gap when conventional stabilizer packages are employed. By utilizing the combination of the copper-based compound and the cerium-based compound in the amounts discussed herein (along with the AEG amounts) thermal stabilization is unexpectedly achieved.

By way of non-limiting example, the copper-based compound of the second heat stabilizer may comprise compounds of mono- or bivalent copper, such as salts of mono- or bivalent copper with inorganic or organic acids or with mono- or bivalent phenols, the oxides of mono- or bivalent copper, or complex compounds of copper salts with ammonia, amines, amides, lactams, cyanides or phosphines, and combinations thereof. In some preferred embodiments, the copper-based compound may comprise salts of mono- or bivalent copper with hydrohalogen acids, hydrocyanic acids, or aliphatic carboxylic acids, such as copper (I) chloride, copper (I) bromide, copper (I) iodide, copper (I) cyanide, copper (II) oxide, copper (II) chloride, copper (II) sulfate, copper (II) acetate, or copper (II) phosphate. Preferably, the copper-based compound is copper iodide and/or copper bromide. The second heat stabilizer may be employed with a halide additive discussed below. Copper stearate, as a second heat stabilizer (not as a stearate additive) is also contemplated.

In some embodiments, the polyamide composition comprises the second heat stabilizer in an amount ranging from 0.01 wt % to 5.0 wt %, e.g., from 0.01 wt % to 4.0 wt %, from 0.02 wt % to 3.0 wt %, from 0.03 to 2.0 wt %, from 0.03 wt % to 1.0 wt %, from 0.04 wt % to 1.0 wt %, from 0.05 wt % to 0.5 wt %, from 0.05 wt % to 0.2 wt %, or from 0.07 wt % to 0.1 wt %. In terms of lower limits, the polyamide composition may comprise greater than 0.01 wt % second heat stabilizer, e.g., greater than 0.02 wt %, greater than 0.03 wt %, greater than 0.035 wt %, greater than 0.04 wt %, greater than 0.05 wt %, greater than 0.07 wt %, or greater than 0.1 wt %. In terms of upper limits, the polyamide composition may comprise less than 5.0 wt % second heat stabilizer, e.g., less than 4.0 wt %, less than 3.0 wt %, less than 2.0 wt %, less than 1.0 wt %, less than 0.5 wt %, less than 0.2 wt %, less than 0.1 wt %, less than 0.05 wt %, or less than 0.035 wt %.

In some embodiments, polyamide composition comprises the second heat stabilizer, e.g., copper-based compound, in an amount ranging from 1 ppm to 1500 ppm, e.g., from 10 ppm to 1200 ppm, from 50 ppm to 1000 ppm, from 50 ppm to 800 ppm, from 100 ppm to 750 ppm, from 200 ppm to 700 ppm, from 300 ppm to 600 ppm, or from 350 ppm to 550 ppm. In terms of lower limits, the polyamide composition comprises the second heat stabilizer in an amount greater than 1 ppm, e.g., greater than 10 ppm, greater than 50 ppm, greater than 100 ppm, greater than 200 ppm, greater than 300 ppm, or greater than 350 ppm. In terms of upper limits, the polyamide composition comprises the second heat stabilizer in an amount less than 1500 ppm, e.g., less than 1200 ppm, less than 1000 ppm, less than 800 ppm, less than 750 ppm, less than 700 ppm, less than 600 ppm, or less than 550 ppm.

In cases where the second heat stabilizer is a copper-based compound, the copper-based compound may be present in the heat stabilizer package (and in the polyamide composition) in the amounts discussed herein with respect to the second heat stabilizer generally.

The weight ratio of the lanthanoid-based heat stabilizer, e.g., the cerium-based heat stabilizer, to the second heat stabilizer, e.g., a copper-based heat stabilizer, may be referred to herein as the “lanthanoid ratio” or the “cerium ratio.” The ranges and limits for cerium ratios also apply to lanthanoids ratios and vice versa.

As noted above, the cerium ratio has unexpectedly been found to greatly affect the overall heat stability of the resultant polyamide composition. In some embodiments, the lanthanoid ratio is less than 8.5, e.g., less than 8.0, less than 7.5, less than 7.0, less than 6.5, less than 6.0, less than 5.5, less than 5.0, less than 4.5, less than 4.0, less than 3.5, less than 3.0, less than 3.5, less than 3.0, less than 2.5, less than 2.0, less than 1.5, less than 1.0, or less than 0.5. In terms of ranges, the lanthanoid ratio may range from 0.1 to 8.5, e.g., from 0.2 to 8.0; from 0.3 to 8.0, from 0.4 to 7.0, from 0.5 to 6.5, from 0.5 to 6, from 0.7 to 5.0, from 1.0 to 4.0, from 1.2 to 3.0, or from 1.5 to 2.5. In terms of lower limits, the lanthanoid ratio may be greater than 0.1, e.g., greater than 0.2, greater than 0.3, greater than 0.5, greater than 0.5, greater than 0.7, greater than 1.0, greater than 1.2, greater than 1.5, greater than 2.0, greater than 3.0, or greater than 4.0.

In some embodiments, the lanthanoid ratio is greater than 14.5, e.g., greater than 15.0, greater than 16.0, greater than 18.0, greater than 20.0, greater than 25.0, greater than 30.0, or greater than 35.0. In terms of ranges, the lanthanoid ratio may range from 14.5 to 50.0, e.g., from 14.5 to 40.0; from 15.0 to 35.0, from 16.0 to 30.0, from 18.0 to 30.0, from 18.0 to 25.0, or from 18.0 to 23.0. In terms of upper limits, the lanthanoid ratio may be less than 50.0, e.g., less than 40.0, less than 35.0, less than 30.0, less than 25.0, or less than 23.0.

In some embodiments, the lanthanoid ratio is greater than 5, e.g., greater than 6.0, greater than 7.0, greater than 8.0, or greater than 9.0. In terms of ranges, the lanthanoid ratio may range from 5.0 to 50.0, e.g., from 5 to 40.0; from 5.0 to 30.0, from 5.0 to 20.0, from 5.0 to 15.0, from 7.0 to 15.0, or from 8.0 to 13.0. In terms of upper limits, the lanthanoid ratio may be less than 50.0, e.g., less than 40.0, less than 30.0, less than 20.0, less than 15.0, or less than 13.0.

As noted herein, the synergistic combination of the AEGs and the heat stabilizers is believed to advantageously form a amine/metal complex, which surprisingly contributes to improvements in high temperature performance. In some embodiments, due to the specific levels of AEGs and the particular lanthanoid compounds, the heat-stabilized polyamide composition comprises an amine/metal complex. In some cases, the heat-stabilized polyamide composition comprises from 1 ppm to 1 wt % (10,000 ppm) amine/metal complex, e.g., from 1 ppm to 5000 ppm, from 10 ppm to 4500 ppm, from 50 ppm to 4000 ppm, from 100 ppm to 4000 ppm, from 500 ppm to 4000 ppm, from 1000 ppm to 5000 ppm, from 2000 ppm to 4000 ppm, from 1500 ppm to 4500 ppm, from 1000 ppm to 3000 ppm, from 1500 ppm to 2500 ppm, or from 2500 ppm to 3500 ppm. In terms of lower limits, the heat-stabilized polyamide composition may comprise greater than 1 ppm amine/metal complex, e.g. greater than 10 ppm, greater than 50 ppm, greater than 100 ppm, greater than 250 ppm, greater than 400 ppm, greater than 500 ppm, greater than 1000 ppm, greater than 1500 ppm, greater than 2000 ppm, or greater than 2500 ppm. In terms of upper limits, the heat-stabilized polyamide composition may comprise less than 10,000 ppm amine/metal complex, e.g., less than 5000 ppm, less than 4500 ppm, less than 4000 ppm, less than 3500 ppm, less than 3000 ppm, less than 2500 ppm, less than 2000 ppm, less than 1500 ppm, or less than 1000 ppm. In some cases, the amine/metal complex is an amine/lanthanoid complex, e.g., an amine/cerium complex; an amine/copper complex; or an amine/lanthanoid/copper complex, e.g., an amine/cerium/copper complex, or combinations thereof. The ranges and limits mentioned herein are applicable to these specific complexes as well.

The polyamide may further comprise (in addition to the first and second heat stabilizers) a halide additive, e.g., a chloride, a bromide, and/or an iodide. In some cases, the purpose of the halide additive is to improve the stabilization of the polyamide composition. Surprisingly, the inventors have discovered that, when employed as described herein, the halide additive works synergistically with the stabilizer package by mitigating free radical oxidation of polyamides. Exemplary halide additives include potassium chloride, potassium bromide, and potassium iodide. In some cases, these additives are utilized in amounts discussed herein.

The halide additive may vary widely. In some cases, the halide additive may be utilized with the second heat stabilizer. In some cases, the halide additive is not the same component as the second heat stabilizer, e.g., the second heat stabilizer, copper halide, is not considered a halide additive. Halide additive are generally known and are commercially available. Exemplary halide additives include iodides and bromides. Preferably, the halide additive comprises a chloride, an iodide, and/or a bromide.

In some embodiments, the halide additive is present in the polyamide composition in an amount ranging from 0.001 wt % to 1 wt %, e.g., from 0.01 wt % to 0.75 wt %, from 0.01 wt % to 0.75 wt %, from 0.05 wt % to 0.75 wt %, from 0.05 wt % to 0.5 wt %, from 0.075 wt % to 0.75 wt %, or from 0.1 wt % to 0.5 wt %. In terms of upper limits, the halide additive may be present in an amount less than 1 wt %, e.g., less than 0.75 wt %, or less than 0.5 wt %. In terms of lower limits, the halide additive may be present in an amount greater than 0.001 wt %, e.g., greater than 0.01 wt %, greater than 0.05 wt %, greater than 0.075 wt %, or greater than 0.1 wt %.

In some embodiments, halide, e.g., iodide, is present in an amount ranging from 30 wppm to 5000 wppm, e.g., from 30 wppm to 3000 wppm, from 50 wppm to 2000 wppm, from 50 wppm to 1000 wppm, from 75 wppm to 750 wppm, from 100 wppm to 500 wppm, from 150 wppm to 450 wppm, or from 200 wppm to 400 wppm. In terms of lower limits, the halide may be present in an amount at least 30 wppm, e.g, at least 50 wppm, at least 75 wppm, at least 100 wppm, at least 150 wppm, or at least 200 wppm. In terms of upper limits, the halide may be present in an amount less than 5000 wppm, e.g., less than 3500 wppm, less than 3000 wppm, less than 2000 wppm, less than 1000 wppm, less than 750 wppm, less than 500 wppm, less than 450 wppm, or less than 400 wppm.

Total halide, e.g., iodide, content in some cases includes iodide from all sources, e.g., first and second heat stabilizers, e.g., copper iodide, and additives, e.g., potassium iodide.

In some cases, the weight ratio of lanthanoid to halide, e.g., iodide, has been shown to demonstrate unexpected heat performance. Without being bound by theory, it is postulated that halide is important to the regeneration of the lanthanoids, e.g., cerium, possibly providing the ability of some cerium (or lanthanum) ions to return to the original state, which leads to improved and more consistent heat performance over time. In some cases, when lanthanoid oxide and/or lanthanoid oxyhydrate are employed, particular (higher) amounts of halide, e.g., iodide, are used in conjunction therewith. Beneficially, when these amounts of iodide and lanthanoids-based heat stabilizer and/or weight ratios thereof are employed, the use of bromine-containing components can advantageously be eliminated. In addition, iodide ion may play a role in stabilizing higher oxidation states of cerium which could further contribute to the heat stability of cerium oxide/oxyhydrate system.

In some cases, the ratio of the weight ratio of the first heat stabilizer, e.g., lanthanoid-based compound, to the halide is less than 0.175, e.g., less than 0.15, less than 0.12, less than 0.1, less than 0.075, less than 0.05, or less than 0.03. In terms of ranges, the weight ratio of the cerium-based compound to the halide may range from 0.001 to 0.174, e.g., from 0.001 to 0.15, from 0.005 to 0.12, from 0.01 to 0.1, or from 0.5 to 0.5. In terms of lower limits, the weight ratio of the cerium-based compound to the halide is at least 0.001, e.g., at least 0.005, at least 0.01, or at least 0.5.

In some cases, the ratio of the weight ratio of the first heat stabilizer, e.g., lanthanoid-based compound, to the halide additive is less than 25, e.g., less than 20, less than 18, or less than 17.5. In terms of ranges, the weight ratio of the cerium-based compound to the halide may range from 0.1 to 25, e.g., from 0.5 to 20, from 0.5 to 18, from 5 to 20, or from 10 to 17.5. In terms of lower limits, the weight ratio of the cerium-based compound to the halide is at least 0.1, e.g., at least 0.5, at least 1, or at least 10.

In some cases, the ratio of the weight ratio of the second heat stabilizer, e.g., copper-based compound, to the halide additive is less than 0.175, e.g., less than 0.15, less than 0.12, less than 0.1, less than 0.075, less than 0.05, or less than 0.03. In terms of ranges, the weight ratio of the cerium-based compound to the halide may range from 0.001 to 0.174, e.g., from 0.001 to 0.15, from 0.005 to 0.12, from 0.01 to 0.1, or from 0.5 to 0.5. In terms of lower limits, the weight ratio of the cerium-based compound to the halide is at least 0.001, e.g., at least 0.005, at least 0.01, or at least 0.5.

In preferred embodiments, the heat-stabilized polyamide preferably may comprise the stearate additives, e.g., calcium stearates, but in small amounts, if any. Generally, stearates are not known to contribute to stabilization; rather, stearate additives are typically used for lubrication and/or to aid in mold release. Because synergistic small amounts are employed, the disclosed heat-stabilized polyamide compositions are able to effectively produce polyamide structures without requiring high amounts of stearate lubricants typically present in conventional polyamides, thus providing production efficiencies. Also, the inventors have found that the small amounts of stearate additive reduces the potential for formation of detrimental stearate degradation products. In particular, the stearate additives have been found to degrade at higher temperatures, giving rise to further stability problems in the polyamide compositions.

In some cases, the polyamide composition beneficially comprises little or no stearates, e.g., calcium stearate or zinc stearate. In some cases the weight ratio of the halide additive to the stearate additive and/or the weight ratio of the second heat stabilizer to the halide additive are maintained within certain ranges and/or limits.

The stearate additive may be present in synergistic small amounts. For example, the polyamide composition may comprise less than 0.3 wt % stearate additive, e.g., less than 0.25 wt %, less than 0.2 wt %, less than 0.15 wt %, less than 0.10 wt %, less than 0.05 wt %, less than 0.03 wt %, less than 0.01 wt %, or less than 0.005 wt %. In terms of ranges, the polyamide composition may comprise from 1 wppm to 0.3 wt % stearate additive, e.g., from 1 wppm to 0.25 wt %, from 5 wppm to 0.1 wt %, from 5 wppm to 0.05 wt %, or from 10 wppm to 0.005 wt %. In terms of lower limits, the polyamide composition may comprise greater than 1 wppm stearate additive, e.g., greater than 5 wppm, greater 10 wppm, or greater than 25 wppm. In some embodiments, the polyamide composition comprises substantially no stearate additive, e.g., comprises no stearate additive.

The inventors have also discovered that when the weight ratio of the halide additive to the stearate additive is maintained within certain ranges and/or limits, the stabilization is synergistically improved. In some embodiments, the weight ratio of halide additive, e.g., bromide or iodide, to stearate additive, e.g., calcium stearate or zinc stearate is less than 45.0, e.g., less than 40.0, less than 35.0, less than 30.0, less than 25.0, less than 20.0, less than 15.0, less than 10.0, less than 5.0, less than 4.1, less than 4.0, or less than 3.0. In terms of ranges, this weight ratio may range from 0.1 to 45, e.g., from 0.1 to 35, from 0.5 to 25, from 0.5 to 20.0, from 1.0 to 15.0, from 1.0 to 10.0, from 1.5 to 8, from 1.5 to 6.0, from 2.0 to 6.0, or from 2.5 to 5.5. In terms of lower limits, this ratio may be greater than 0.1, e.g., greater than 0.5, greater than 1.0, greater than 1.5, greater than 2.0, greater than 2.5, greater than 5.0, or greater than 10.0.

In some embodiments, the halide additive is present in the polyamide composition in an amount ranging from 0.001 wt % to 1 wt %, e.g., from 0.01 wt % to 0.75 wt %, from 0.01 wt % to 0.75 wt %, from 0.05 wt % to 0.75 wt %, from 0.05 wt % to 0.5 wt %, from 0.075 wt % to 0.75 wt %, or from 0.1 wt % to 0.5 wt %. In terms of upper limits, the halide additive may be present in an amount less than 1 wt %, e.g., less than 0.75 wt %, or less than 0.5 wt %. In terms of lower limits, the halide additive may be present in an amount greater than 0.001 wt %, e.g., greater than 0.01 wt %, greater than 0.05 wt %, greater than 0.075 wt %, or greater than 0.1 wt %.

In some cases, the polyamide composition comprises little or no antioxidant additives, e.g., phenolic antioxidants. As noted above, antioxidants are known polyamide stabilizers that are unnecessary in the polyamide compositions of the present disclosure. Preferably, the polyamide composition comprises no antioxidants. As a result, there is advantageously little need for antioxidant additives, and production efficiencies are achieved. For example, the polyamide composition may comprise less than 5 wt % antioxidant additive, e.g., less than 4.5 wt %, less than 4.0 wt %, less than 3.5 wt %, less than 3.0 wt %, less than 2.5 wt %, less than 2.0 wt %, less than 1.5 wt %, less than 1.0 wt %, less than 0.5 wt %, or less than 0.1 wt %. In terms of ranges, the polyamide composition may comprise from 0.0001 wt % to 5 wt % antioxidants, e.g., from 0.001 wt % to 4 wt %, from 0.01 wt % to 3 wt %, from 0.01 wt % to 2 wt %, from 0.01 wt % to 1 wt %, from 0.01 wt % to 0.5 wt %, or from 0.05 wt % to 0.5 wt %. In terms of lower limits, the polyamide composition may comprise greater than 0.0001 wt % antioxidant additive, e.g., greater than 0.001 wt %, greater than 0.01 wt %, greater than 0.05, or greater than 0.1 wt %.

It has been discovered that when preparing the heat-stabilized polyamide compositions disclosed herein, the lanthanoid-based compound can beneficially be selected on the basis of that activation temperature. It has also been discovered that the lanthanoid-based compound's ability to stabilize may not fully activate at lower temperatures. In some cases, the lanthanoid-based compound may have an activation temperature greater than 180° C. e.g., greater than 183° C., greater than 185° C., greater than 187° C., greater than 190° C., greater than 192° C., greater than 195° C., greater than 197° C., greater than 200° C., greater than 202° C., greater than 205° C., greater than 207° C., greater than 210° C., greater than 212° C., or greater than 215° C. In terms of ranges, the lanthanoid-based compound may have an activation temperature ranging from 180° C. to 230° C., e.g., from 180° C. to 220° C., from 185° C. to 230° C., from 185° C. to 220° C., from 190° C. to 220° C., from 190° C. to 210° C., from 195° C. to 205° C., or from 200° C. to 205° C. In terms of upper limits, the lanthanoid-based compound may have an activation temperature less than 230° C. e.g., less than 220° C., less than 210° C., or less than 205° C. In preferred embodiments, the lanthanoid-based compound has an activation temperature of approximately 230° C.

The activation temperature of a polyamide heat stabilizer may be an “effective activation temperature.” The effective activation temperature relates to the temperature at which the stabilization functionality of the additive becomes more active than the thermo-oxidative degradation of the polyamide composition. The effective activation temperature reflects a balance between the stabilization kinetics and the degradation kinetics.

In some cases, when a heat stabilization target is known, the cerium-based compound, or the combination of cerium-based heat compounds, can be selected based on the heat stabilization target. For example, in some embodiments, the cerium-based compound is preferably selected such that the cerium-based compound has an activation temperature falling within the ranges and limits mentioned herein.

In some embodiments, the second heat stabilizer may have an activation temperature less than 200° C. e.g., less than 190° C., less than 180° C., less than 170° C., less than 160° C., less than 150° C., or less than 148° C. In terms of lower limits, the second heat stabilizer may have an activation temperature greater than 100° C. e.g., greater than 110° C., greater than 120° C., greater than 130° C., greater than 140° C., or greater than 142° C. In terms of ranges, the second heat stabilizer may have an activation temperature ranging from 100° C. to 200° C., e.g., from 120° C. to 160° C., from 110° C. to 190° C., from 110° C. to 180° C., from 120° C. to 170° C., from 130° C. to 160° C., from 140° C. to 150° C., or from 142° C. to 148° C. Effective activation temperatures may be within these ranges and limits as well.

In preferred embodiments, the second heat stabilizer is selected such that it has an activation temperature lower than the activation temperature of the lanthanoid-based compound. By utilizing a second heat stabilizer with a lower activation temperature than that of the lanthanoid-based compound, the resultant polyamide composition may show increased heat stability and/or heat stability over a broader range of temperatures. In some embodiments, the activation temperature of the lanthanoid-based compound is greater than the activation temperature of the second heat stabilizer, e.g., the copper-based compound, e.g., at least 10% greater, at least 12% greater, at least 15% greater, at least 17% greater, at least 20% greater, at least 25% greater, at least 30% greater, at least 40% greater, or at least 50% greater.

As noted above, some conventional stabilizer packages may rely on combinations of second heat stabilizers, e.g., stearates (such as calcium stearate or zinc stearate), hypophosphoric acids, and/or hypophosphates. It has been discovered that the use of the aforementioned cerium-based heat stabilizer and lower amounts, if any, of these compounds has been surprisingly found to improve the stabilization profile of the resultant polyamide composition. In some embodiments, the polyamide composition comprises less than 0.5 wt % of hypophosphoric acid and/or a hypophosphate, e.g., less than 0.3 wt %, less than 0.1 wt %, less than 0.05 wt %, or less than 0.01 wt %. In terms of ranges, the polyamide composition may comprise from 1 wppm to 0.5 wt % of hypophosphoric acid and/or a hypophosphate, e.g., from 1 wppm to 0.3 wt %, from 1 wppm to 0.1 wt %, from 5 wppm to 0.05 wt %, or from 5 wppm to 0.01 wt %. In a preferred embodiment, the polyamide composition comprises no hypophosphoric acid and/or a hypophosphate.

Some embodiments of the heat-stabilized polyamide compositions comprise a filler, e.g., glass. In these cases, the filler may be present in an amount ranging from 20 wt % to 60 wt %, e.g., from 25 wt % to 55 wt %, or from 30 wt % to 50 wt %. In terms of lower limits, the polyamide compositions may comprise at least 20 wt % filler, e.g., at least 25 wt %, at least 30 wt %, at least 35 wt %, or at least 40 wt %. In terms of upper limits, the polyamide compositions may comprise less than 60 wt % filler, e.g., less than 55 wt %, less than 50 wt %, less than 45 wt %, or less than 40 wt %. The ranges and limits for the other components disclosed herein are based on a “filled” composition. For a neat composition, the ranges and limits may need to be adjusted to compensate for the lack of filler. As one example, a neat composition may comprise from 57 wt % to 98 wt % amide polymer, e.g., from 67 wt % to 87 wt %; from 0.1 wt % to 10 wt % nigrosine, e.g., from 0.5 to 5 wt %; from 5 wt % to 40 wt % additional polyamide, e.g., from 5 wt % to 30 wt %; from 0.1 wt % to 10 wt % carbon black, e.g., from 0.1 wt % to 5 wt %; from 0.05 wt % to 10 wt % first stabilizer, e.g., from 0.05 to 5 wt %; and from 0.05 wt % to 10 wt % second stabilizer, e.g., from 0.05 wt % to 5 wt %.

The material of the filler is not particularly limited and may be selected from polyamide fillers known in the art. By way of non-limiting example, the filler may comprise glass- and/or carbon fibers, particulate fillers, such as mineral fillers based on natural and/or synthetic layer silicates, talc, mica, silicate, quartz, titanium dioxide, wollastonite, kaolin, amorphous silicic acids, magnesium carbonate, magnesium hydroxide, chalk, lime, feldspar, barium sulphate, solid or hollow glass balls or ground glass, permanently magnetic or magnetisable metal compounds and/or alloys and/or combinations thereof, and also combinations thereof.

In other cases, the heat-stabilized polyamide compositions is a “neat” composition, e.g., the polyamide composition comprises little or no filler. For example the polyamide compositions may comprise less than 20 wt % filler, e.g., less than 17 wt %, less than 15 wt %, less than 10 wt %, or less than 5 wt %. In terms of ranges, the polyamide compositions may comprise from 0.01 wt % to 20 wt % filler, e.g., from 0.1 wt % to 15 wt % or from 0.1 wt % to 5 wt %. In such cases, the amounts of other components may be adjusted accordingly based on the aforementioned component ranges and limits. It is contemplated that a person of ordinary skill in the art would be able to adjust the concentration of the other components of the polyamide composition in light of the inclusion or exclusion of a glass filler.

Both the filled and neat embodiments each demonstrate the surprising improved mechanical properties. For unfilled resins of polyamides, however, thermal stability is not typically measured by references to the tensile strength of the polyamide composition; rather, thermal stability is often measured using relative thermal index (RTI). RTI refers to the thermal classification of a material by comparing the performance of the material against the performance of a known or reference material. Often, RTI assesses the ability of the material to withstand exposure to high temperatures by measuring the ability of the material to maintain at least 50% of its tensile strength when exposed to various temperatures for set amounts of time. The non-glass-filled embodiments of the heat-stabilized polyamide compositions demonstrate improved RTI.

In one embodiment, the amide polymer has an amine end group level greater than 65 ueq/gram, the lanthanoid-based heat stabilizer comprises cerium oxide and/or cerium oxyhydrate, the polyamide composition has a cerium content ranging from 10 ppm to 9000 ppm; the second heat stabilizer comprises a copper based compound; the polyamide composition comprises at least 1 wppm amine/cerium/copper complex; and the polyamide composition has a tensile strength of at least 100 MPa, or at least 110 MPa, when heat aged for 3000 hours at a temperature of at least 180° C. and measured at 23° C.

In one embodiment, the amide polymer has an amine end group level greater than 65 ueq/gram, the amide polymer comprises PA-6,6, or PA-6,6/6T, or combinations thereof, the composition comprises an additional low AEG polymer, the lanthanoid-based heat stabilizer comprises a cerium-based heat stabilizer, the second heat stabilizer comprises a copper based compound, the polyamide composition has a cerium ratio ranging from 5.0 to 50.0, the polyamide composition comprises at least 1 wppm amine/cerium/copper complex; and the polyamide composition has a tensile strength of at least 100 MPa, or at least 110 MPa, when heat aged for 3000 hours at a temperature of at least 180° C. and measured at 23° C.

In one embodiment, the amide polymer has an amine end group level greater than 65 ueq/gram; the lanthanoid-based compound comprises cerium oxide, cerium oxyhydrate, or cerium hydrate, or combinations thereof and wherein the polyamide composition has a cerium content ranging from 10 ppm to 9000 ppm; the second heat stabilizer comprises a copper-based compound; the polyamide composition comprises at least 1 wppm amine/cerium/copper complex; and when heat aged for 2500 hours over an entire temperature range of from 190° C. to 220° C., the polyamide composition demonstrates a tensile strength retention of greater than 59%, as measured at 23° C.; and when heat aged for 3000 hours over an entire temperature range of from 190° C. to 220° C., the polyamide composition demonstrates an impact resilience of greater than 17 KJ/m², as measured at 23° C.

In one embodiment, the amide polymer has an amine end group level greater than 65 ucq/gram; the amide polymer comprises from 70 wt % to 90 wt % high AEG PA-6,6; the composition comprises from 10 wt % to 30 wt % additional polyamide, the lanthanoid-based compound comprises a cerium-based compound; the second heat stabilizer comprises a copper-based compound; and when heat aged for 3000 hours at a temperature of 210° C.; the polyamide composition demonstrates a tensile strength greater than 82 MPa, as measured at 23° C.; and when heat aged for 3000 hours at a temperature of 210° C.; the polyamide composition demonstrates a tensile strength retention greater than 41%, as measured at 23° C.; and when heat aged for 3000 hours at a temperature of 210° C.; the polyamide composition demonstrates an impact resilience greater than 13 KJ/m², as measured at 23° C.

### Performance Characteristics

The aforementioned heat-stabilized polyamide compositions demonstrate surprising performance results. For example, the polyamide compositions demonstrate superior tensile performance over broad (heat age) temperature ranges, even over known performance gaps, e.g., temperature gaps (for example over the entire range from 190° C. to 220° C.). For the reasons discussed above, performance over the entire range is particularly desirable. These performance parameters are exemplary and the examples support other performance parameters that are contemplated by the disclosure. For example, other performance characteristics taken at other heat age temperatures, for example at 220° C., and heat age durations, for example for 3000 hours, are contemplated and may be utilized to characterize the disclosed polyamide compositions.

Furthermore, the heat stabilizer packages have been shown to retard the damage to the polyamides even when exposed to higher temperature. When tensile strength is measured at higher temperatures, the tensile strength of the heat-stabilized polyamide compositions remains surprisingly high. Typically, tensile strength of polyamide compositions is much lower when measured at higher temperatures. While that trend remains true of the heat-stabilized polyamide compositions disclosed herein, the actual tensile strength remains surprisingly high even when measured at temperatures.

Generally, tensile strength measurements may be conducted under ISO 527-1 (2019), Charpy notched impact energy loss of the polyamide composition may be measured using a standard protocol such as ISO 179-1 (2010), and heat aging measurements may be conducted under ISO 180 (2018).

### Tensile Strength Retention

In some embodiments, when heat aged for 2500 hours over an entire temperature range of from 190° C. to 220° C. and measured at 23° C., the polyamide composition demonstrates a tensile strength retention of greater than 50%, e.g., greater than 55%, greater than 59%, greater than 60%, greater than 61.5%, or greater than 62%.

In some embodiments, when heat aged for 3000 hours over an entire temperature range of from 190° C. to 220° C. and measured at 23° C., the polyamide composition demonstrates a tensile strength retention of greater than 45%, e.g., greater than 45%, e.g., greater than 49%, greater than 50%, greater than 53%, or greater than 54%.

In some embodiments, when heat aged for 2500 hours at a temperature of 210° C. and measured at 23° C., the polyamide composition demonstrates a tensile strength retention greater than 50%, e.g., greater than 53%, greater than 55%, greater than 60%, greater than 62%, or greater than 63%.

In some embodiments, when heat aged for 3000 hours at a temperature of 210° C. and measured at 23° C., the polyamide composition demonstrates a tensile strength retention greater than 41%, e.g., greater than 43%, greater than 45%, greater than 500%, greater than 52%, or greater than 53%.

### Tensile Strength

In some embodiments, when heat aged for 2500 hours over an entire temperature range of from 190° C. to 220° C. and measured at 23° C., the polyamide composition demonstrates a tensile strength of greater than 98 MPa, e.g., greater than 100 MPa, greater than 105 MPa, greater than 110 MPa, greater than 115 MPa, greater than 118 MPa, greater than 119 MPa, or greater than 120 MPa.

In some embodiments, when heat aged for 3000 hours over an entire temperature range of from 190° C. to 220° C. and measured at 23° C., the polyamide composition demonstrates a tensile strength of greater than 81 MPa, e.g., 85 MPa, greater than 90 MPa, greater than 95 MPa, greater than 100 MPa, greater than 101 MPa, greater than 102 MPa, or greater than 105 MPa.

In some embodiments, when heat aged for 2500 hours at a temperature of 210° C. and measured at 23° C., the polyamide composition demonstrates a tensile strength greater than 99 MPa, e.g., greater than 105 MPa, greater than 110 MPa, greater than 115 MPa, greater than 120 MPa, or greater than 125 MPa.

In some embodiments, when heat aged for 3000 hours at a temperature of 210° C. and measured at 23° C., the polyamide composition demonstrates a tensile strength greater than 81 MPa, e.g., greater than 82 MPa, greater than 85 MPa, greater than 90 MPa, greater than 95 MPa, greater than 100 MPa, or greater than 105 MPa.

In some embodiment, the polyamide composition demonstrates a tensile strength of at least 75 MPa, e.g., at least 80 MPa, at least 90 MPa, at least 100 MPa, or at least 110 MPa, when heat aged for 3000 hours at a temperature of at least 180° C. and measured at 23° C. In terms of ranges, the tensile strength may range from 75 MPa to 175 MPa, e.g., from 80 MPa to 160 MPa, from 85 MPa to 160 MPa, or from 90 MPa to 160 MPa.

In some cases, the polyamide composition demonstrates a tensile strength of at least 25 MPa, e.g., at least 15 MPa, at least 25 MPa, at least 35 MPa, at least 40 MPa, at least 50 MPa, at least 60 MPa, or at least 80 MPa, when heat aged for 3000 hours at a temperature of at least 190° C. and measured at 190° C. In terms of ranges, the tensile strength may range from 15 MPa to 100 MPa, e.g., from 25 MPa to 100 MPa, from 35 MPa to 90 MPa, from 40 MPa to 90 MPa, from 40 MPa to 75 MPa, or from 40 MPa to 65 MPa. Polyamide compositions that demonstrate such high tensile strength after having been exposed to temperatures such as these constitute a marked improvement over other methods of heat-stabilizing polyamides known in the art.

In one embodiment, the polyamide composition demonstrates a tensile strength of at least 1 MPa, e.g., at least 5 MPa, at least 10 MPa, at least 12 MPa, at least 15 MPa, at least 20 MPa, or at least 30 MPa, when heat aged for 3000 hours at a temperature of at least 230° C. and measured at 23° C. In terms of ranges, the tensile strength may range from 1 MPa to 100 MPa, e.g., from 5 MPa to 100 MPa, from 5 MPa to 50 MPa, from 5 MPa to 40 MPa, or from 10 MPa to 30 MPa. Although these tensile strengths decrease, these values are still surprisingly higher than those of conventional polyamide compositions that employ conventional stabilizer packages.

In one embodiment, the polyamide composition demonstrates a tensile strength of at least 50 MPa, e.g., at least 55 MPa, at least 60 MPa, at least 70 MPa, at least 80 MPa, at least 100 MPa, at least 125 MPa, or at least 200 MPa when heat aged for 3000 hours at a temperature ranging from 190° C. to 210° C. and measured at 23° C. In terms of ranges, the tensile strength may range from 50 MPa to 150 MPa, e.g., from 60 MPa to 125 MPa, from 70 MPa to 100 MPa, from 75 MPa to 95 MPa, or from 80 MPa to 95 MPa.

In one embodiment, the polyamide composition demonstrates a tensile strength of at least 1 MPa, e.g., at least 5 MPa, at least 10 MPa, at least 12 MPa, at least 15 MPa, at least 20 MPa, or at least 30 MPa, when heat aged for 3000 hours at a temperature at least 190° C. and measured at 190° C. In terms of ranges, the tensile strength may range from 1 MPa to 100 MPa, e.g., from 5 MPa to 100 MPa, from 5 MPa to 50 MPa, from 5 MPa to 40 MPa, or from 80 MPa to 90 MPa.

Although these tensile strengths decrease, these values are still surprisingly higher than those of conventional polyamide compositions that employ conventional stabilizer packages.

### Tensile Modulus

In some embodiments, when heat aged for 3000 hours over an entire temperature range of from 190° C. to 220° C. and measured at 23° C., the polyamide composition demonstrates a tensile modulus of greater than 9750 MPa, e.g., greater than 10000 MPa, greater than 11000 MPa, greater than 11110 MPa, greater than 11200 MPa, greater than 11300 MPa, greater than 11340 MPa, or greater than 11500 MPa.

Tensile properties are not the only mechanical properties of polyamides that suffer from exposure to high temperatures. The damage to polyamides caused by heat manifests itself in a number of ways. It has been found that the heat-stabilized polyamide compositions also show improved resilience to other forms of damage. That is to say, the polyamide compositions exhibit other desirable mechanical properties after having been exposed to high temperatures. One such property is impact resilience. Impact resilience is a metric that relates to the durability of the polyamide composition.

### Impact Resilience

In some embodiments, when heat aged for 3000 hours over an entire temperature range of from 190° C. to 220° C. and measured at 23° C., the polyamide composition demonstrates an impact resilience of greater than 13 KJ/m², e.g., greater than 15 KJ/m², greater than 16 KJ/m², greater than 17 KJ/m², greater than 18 KJ/m², or greater than 19 KJ/m².

In some embodiments, when heat aged for 2500 hours at a temperature of 210° C. and measured at 23° C., the polyamide composition demonstrates an impact resilience of greater than 16 KJ/m², e.g., greater than 20 KJ/m², greater than 22 KJ/m², greater than 24 KJ/m², greater than 25 KJ/m², or greater than 28 KJ/m².

In some embodiments, when heat aged for 3000 hours at a temperature of 210° C. and measured at 23° C., the polyamide composition demonstrates an impact resilience of greater than 13 KJ/m², e.g., greater than 15 KJ/m², greater than 18 KJ/m², greater than 20 KJ/m², greater than 21 KJ/m², or greater than 22 KJ/m².

In some embodiments, when heat aged for 3000 hours at a temperature of 190° C. and measured at 23° C., the polyamide composition demonstrates an impact resilience of greater than 16 KJ/m², e.g., greater than 16.5 kJ/m², greater than 17 KJ/m², greater than 17.5 kJ/m², greater than 18 KJ/m², or greater than 19 KJ/m².

Some embodiments of the heat-stabilized polyamide composition exhibit an impact resilience of greater than 25 KJ/m², e.g., greater than 30 KJ/m², greater than 35 KJ/m², greater than 40 KJ/m², greater than 45 KJ/m², greater than 50 KJ/m², greater than 70 KJ/m², greater than 80 KJ/m², or greater than 100 KJ/m², when measured by ISO 179 (2018). In terms of ranges, the heat-stabilized polyamide composition exhibit an impact resilience ranging from 25 kJ/m² to 500 kJ/m², from 30 kJ/m² to 250 kJ/m², from 35 KJ/m² to 150 kJ/m², from 35 KJ/m² to 100 KJ/m², from 25 KJ/m² to 75 KJ/m², or from 35 kJ/m² to 750 KJ/m².

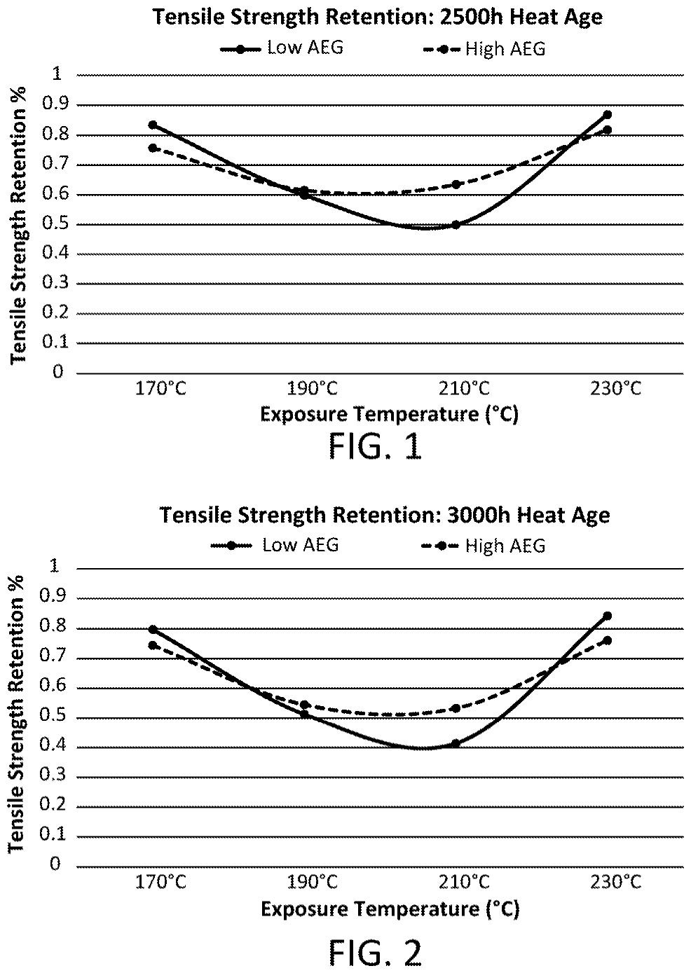

Additional performance comparisons, e.g., performance ranges and limits, can be readily gleaned from Tables 2a and 2b and FIGS. 1 and 2.

### Process of Production

The present disclosure also relates to processes of producing the heat-stabilized polyamide compositions. A preferred method includes providing a polyamide, determining a desired heat stabilization target, selecting an AEG level based on the desired heat stabilization target, and adjusting the AEG level in the polyamide to form a heat-stabilized polyamide composition. For example, if a tensile strength of at least 75 MPa, when heat aged for 3000 hours at a temperature ranging from 180° C. to 220° C. (and measured at 23° C.) is desired, the AEG levels disclosed herein may be utilized to achieve the desired performance in the specific heat age temperature range (the other heat age temperature ranges and limits discussed herein may be similarly employed in this manner). By doing so the AEG levels can be employed to produce a polyamide composition that exhibits heat stability at the desired temperature.

In some cases, the heat-stabilized polyamide composition (after or during heat aging) comprises the low amounts of cyclopentanone discussed herein.

The method can also include the further steps of selecting a heat stabilizer package based on the desired heat stabilization target and the AEG level. The heat stabilizers, e.g., the cerium-based heat stabilizer, can be selected on the basis of its activation temperature. Similarly, additional heat stabilizers can also be selected on the basis of the desired heat stabilization level and/or the selected cerium-based heat stabilizer. The resultant polyamide composition will have the beneficial performance characteristics discussed herein.

In preferred embodiments of this process, the cerium-based stabilizer is a cerium based ligand and the second heat stabilizer is a copper-based heat stabilizer. In these embodiments, the selection of the cerium-based ligand may further comprise the selection of a ligand component of the cerium-based ligand based on the desired heat stabilization level.

Preferably, the result of this process is a heat-stabilized polyamide composition that has a tensile strength of at least 200 MPa, when heat aged for 3000 hours at a temperature of at least 190° C. and measured at 23° C.

In addition, the disclosure also relates to a process for producing the heat-stabilized polyamide compositions. The process may comprise the steps of providing an amide polymer; adding to the polymer a cerium-based heat stabilizer and a second heat stabilizer, as discussed herein, to form an intermediate polyamide composition, heating the intermediate polyamide composition to a predetermined temperature, e.g., at least 180° C., and cooling the heated intermediate polyamide composition to form the heat-stabilized polyamide composition. Beneficially, the heating of the polyamide serves to activate the stabilizer package, which in turn heat stabilizes the intermediate polyamide composition. As a result, the (cooled) heat-stabilized polyamide composition will have improved performance characteristics, as discussed herein.

Some embodiments of the process include the intermediate steps of grinding the amide polymer and adding the cerium-based heat stabilizer to the ground amide polymer. The remaining components are then added to the resultant ground amide polymer and cerium-based heat stabilizer mixture. The inventors have discovered that this process advantageously results in a more uniform dispersion of the cerium-based heat stabilizer throughout the final heat-stabilized polyamide compositions.

### Molded Articles

The present disclosure also relates to articles that include any of the provided impact-modified polyamide compositions. The article can be produced, for example, via conventional injection molding, extrusion molding, blow molding, press molding, compression molding, or gas assist molding techniques. Molding processes suitable for use with the disclosed compositions and articles are described in U.S. Pat. Nos. 8,658,757; 4,707,513; 7,858,172; and 8,192,664, each of which is incorporated herein by reference in its entirety for all purposes. Examples of articles that can be made with the provided polyamide compositions include those used in electrical and electronic applications (such as, but not limited to, circuit breakers, terminal blocks, connectors and the like), automotive applications (such as, but not limited to, air handling systems, radiator end tanks, fans, shrouds, and the like), furniture and appliance parts, and wire positioning devices such as cable ties.

### Examples

Example 1 and Comparative Example A were prepared by combining components as shown in Table 1 and compounding in a twin screw extruder. Polymers were melted, additives were added to the melt, and the resultant mixture was extruded and pelletized. Percentages are expressed as weight percentages. Example 1 employed a PA-6,6 polyamide having amine end groups ranging from 78 μeq/gram-85 μeq/gram. Comparative Example A employed a PA-6,6 polyamide having a lower amount of amine end groups-ranging from 40 μeq/gram-44. μeq/gram. A first heat stabilizer, e.g., a lanthanoid-based heat stabilizer, was used in combination with second heat stabilizer, e.g., comprising a copper stabilizer and a metal halide.

TABLE 1
Example and Comparative Example Compositions

| Component | Ex. 1 | Comp. Ex. A |
|---|---|---|
| PA-66 | 50.24% | 50.24% |
| | (high AEG) | (low AEG) |
| Addt'l PA | 12.0% | 12.0% |
| | (low AEG) | (low AEG) |
| Glass Fiber | 35.0% | 35.0% |
| Cu Heat Stabilizer | 0.60% | 0.60% |
| (masterbatch) | | |
| Lanthanoid Heat | 0.50% | 0.50% |
| Stabilizer | | |
| Carbon Black | 0.15% | 0.15% |
| (masterbatch) | | |
| Nigrosine | 1.5% | 1.5% |
| (masterbatch) | | |

Panels were formed from the pellets, and the panels were heat aged at multiple temperatures and measured (at various temperatures and heat age times) for tensile strength, tensile strength retention, tensile elongation, tensile modulus, and impact resilience. The results for the 2500 hour and 3000 hour heat aging are shown in Tables 2a and 2b. The overall tensile retention results (temperature range from 170° C. to 230° C.) are displayed graphically in FIGS. 1 and 2.

TABLE 2a
Test Results

| | | 2500 Hours | | 3000 Hours | |
|---|---|---|---|---|---|
| | | 190° C. | | 190° C. | |
| | | | Comp. | | Comp. |
| | Units | Ex. 1 | Ex. A | Ex. 1 | Ex. A |
| Tensile | MPa | 122.25 | 118.04 | 108.2 | 101.126 |
| Strength | | | | | |
| Tensile Retention | % | 62% | 59% | 54% | 51% |
| Tensile | % | 1.273 | 1.804 | 1.225 | 1.1802 |
| Elongation | | | | | |
| Tensile Modulus | MPa | 12120 | 10658.8 | 12315 | 11106 |
| Impact resilience; | kJ/m² | 18.479 | 19.713 | 19.985 | 16.9802 |
| Un-notched | | | | | |
| Charpy; 23° C. | | | | | |
| | | 200° C. | | 200° C. | |
| Tensile | MPa | 137.3 | — | 124 | — |
| Strength | | | | | |
| Tensile Retention | % | 69% | — | 62% | — |
| Tensile | % | 1.58 | — | 1.255 | — |
| Elongation | | | | | |
| Tensile Modulus | MPa | 11200 | — | 11992 | — |
| Impact resilience; | kJ/m² | 28.96 | — | 26.435 | — |
| Un-notched | | | | | |
| Charpy; 23° C. | | | | | |

TABLE 2b
Test Results

| | | 2500 Hours | | 3000 Hours | |
|---|---|---|---|---|---|
| | | 210° C. | | 210° C. | |
| | | | Comp. | | Comp. |
| | Units | Ex. 1 | Ex. A | Ex. 1 | Ex. A |
| Tensile | MPa | 126.04 | 98.53 | 105.818 | 81.624 |
| Strength | | | | | |
| Tensile | % | 63% | 50% | 53% | 41% |
| Retention | | | | | |
| Tensile | % | 1.254 | 1.088586 | 1.086 | 0.9392 |
| Elongation | | | | | |
| Tensile | MPa | 12208 | 11533.6 | 11346 | 9750.2 |
| Modulus | | | | | |
| Impact | kJ/m² | 28.807 | 16.514 | 21.688 | 13.0348 |
| resilience; | | | | | |
| Un-notched | | | | | |
| Charpy; | | | | | |
| 23° C. | | | | | |
| | | 220° C. | | 220° C. | |
| Tensile | MPa | 152.467 | — | 155.125 | — |
| Strength | | | | | |
| Tensile | % | 77% | — | 78% | — |
| Retention | | | | | |
| Tensile | % | 1.523 | — | 1.575 | — |
| Elongation | | | | | |
| Tensile | MPa | 12780 | — | 14485 | — |
| Modulus | | | | | |
| Impact | kJ/m² | 39.261 | — | 40.65 | — |
| resilience; | | | | | |
| Un-notched | | | | | |
| Charpy; | | | | | |
| 23° C. | | | | | |

As shown, heat age performance (at 2500 and 3000 hours) was surprisingly improved in the 190° C. to 220° C. temperature range. In particular tensile retention was unexpectedly improved throughout this temperature range. For example, at 2500 hour heat age, tensile strength retention at 190° C. was 62% for Ex. 1 and 59% for Comp. Ex. A—a 5% improvement; and tensile strength retention at 210° C. was 63% for Ex. 1 and 50% for Comp. Ex. A—a 26% improvement. Also, for 3000 hour heat age, tensile strength retention at 190° C. was 54% for Ex. 1 and 51% for Comp. Ex. A—a 6% improvement; and tensile strength retention at 210° C. was 53% for Ex. 1 and 41% for Comp. Ex. A—a 29% improvement. These improvements are significant, especially at higher temperatures.

The improvements in tensile strength retention are also displayed in FIG. 1 (2500 hours heat age) and 2 (3000 hours heat age). These FIGS. show the unexpected tensile retention improvements in “the dip”—at 190° C. to 220° C. A flatter tensile strength retention vs. temperature curve in the 190° C. to 220° C. range is highly desirable. FIGS. 1 and 2 show that the compositions of Example 1 demonstrated significant tensile strength retention in this temperature range—the curves for Ex. 1 are significantly above (y-axis) the curves for Comp. Ex. A.

In addition to the surprising tensile retention improvements, the working examples also demonstrated significant tensile strength improvements throughout the 190° C. to 220° C. temperature range. For example, at 2500 hour heat age, tensile strength at 190° C. was 122 MPa for Ex. 1 and 118 MPa for Comp. Ex. A—a 3% improvement; and tensile strength at 210° C. was 126 MPa for Ex. 1 and 99 MPa for Comp. Ex. A—a 27% improvement. Also, for 3000 hour heat age, tensile strength at 190° C. was 108 MPa for Ex. 1 and 101 MPa for Comp. Ex. A—a 7% improvement; and tensile strength at 210° C. was 106 MPa for Ex. 1 and 82 MPa for Comp. Ex. A—a 29% improvement.

Also, impact resilience (and the combination with tensile performance and impact resilience) was improved. Typically, polymer compositions that demonstrate good tensile performance have less than desirable impact resilience performance and vice versa. For example, at 2500 hour heat age, impact resilience at 210° C. was 29 KJ/m² for Ex. 1 and 17 KJ/m² for Comp. Ex. A—a 70% improvement. Also, for 3000 hour heat age, impact resilience at 190° C. was 20 kJ/m² for Ex. 1 and 17 KJ/m² for Comp. Ex. A—an 18% improvement; and impact resilience at 210° C. was 22 kJ/m² for Ex. 1 and 13 KJ/m² for Comp. Ex. A—a 70% improvement.

Additional performance comparisons can be readily gleaned from Tables 2a and 2b and FIGS. 1 and 2.

### Embodiments

The following embodiments are contemplated. All combinations of features and embodiments are contemplated.

Embodiment 1: A heat-stabilized polyamide composition comprising from 25 wt % to 99 wt % % of an amide polymer having an amine end group level greater than 50 μeq/gram, wherein the polyamide composition has a tensile strength of at least 75 MPa, when heat aged for 3000 hours at a temperature of at least 180° C. and measured at 23° C.

Embodiment 2: An embodiment of embodiment 1, wherein the amide polymer has an amine end group level ranging from 65 μeq/gram to 75 μeq/gram.

Embodiment 3: An embodiment of any of embodiments 1 and 2, wherein the amide polymer has an amine end group level greater than 65 μeq/gram.

Embodiment 4: An embodiment of any of embodiments 1-3, comprising at least 1 wppm amine/metal complex.

Embodiment 5: An embodiment of any of embodiments 1-4, wherein the composition comprises a heat stabilizer package comprising a lanthanoid-based heat stabilizer.

Embodiment 6: An embodiment of any of embodiments 1-5, comprising from 0.01 wt % to 10 wt % of the lanthanoid-based heat stabilizer.

Embodiment 7: An embodiment of any of embodiments 1-6, wherein the composition comprises a heat stabilizer package comprising a second heat stabilizer.

Embodiment 8: An embodiment of any of embodiments 1-7, wherein the wherein the amide polymer comprises PA-6, PA-6,6, or PA-6,6/6T, or combinations thereof.

Embodiment 9: An embodiment of any of embodiments 1-8, wherein the amide polymer has a relative viscosity ranging from 3 to 100.

Embodiment 10: An embodiment of any of embodiments 1-9, wherein the lanthanoid-based heat stabilizer is a cerium-based heat stabilizer.

Embodiment 11: An embodiment of any of embodiments 1-10, wherein the second heat stabilizer comprises a copper-based compound.

Embodiment 12: An embodiment of any of embodiments 1-11, further comprising at least 1 wppm amine/cerium/copper complex.

Embodiment 13: An embodiment of any of embodiments 1-12, wherein the lanthanoid-based heat stabilizer comprises a lanthanoid ligand selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates, 2-ethylhexanoates, or combinations thereof.

Embodiment 14: An embodiment of any of embodiments 1-13, wherein the second heat stabilizer is present in an amount ranging from 0.01 wt % to 5 wt %.

Embodiment 15: An embodiment of any of embodiments 1-14, wherein the lanthanoid-based heat stabilizer is a cerium-based heat stabilizer and the second heat stabilizer comprises a copper-based compound.

Embodiment 16: An embodiment of any of embodiments 1-15, further comprising a halide additive, and less than 0.3 wt % of a stearate additive.

Embodiment 17: An embodiment of any of embodiments 1-16, wherein the amide polymer comprises greater than 90 wt %, based on the total weight of the amide polymer, of a low caprolactam content polyamide; and less than 10 wt %, based on the total weight of the amide polymer, of a non-low caprolactam content polyamide.

Embodiment 18: An embodiment of any of embodiments 1-17, wherein the wherein the low caprolactam content polyamide comprises PA-6,6/6 and/or PA-6,6/6T/6.

Embodiment 19: An embodiment of any of embodiments 1-18, wherein the amide polymer comprises greater than 90 wt %, based on the total weight of the amide polymer, of a low melt temperature polyamide; and less than 10 wt %, based on the total weight of the amide polymer, of a non-low melt temperature polyamide.

Embodiment 20: An embodiment of any of embodiments 1-19, wherein the amide polymer has an amine end group level greater than 65 μeq/gram; the lanthanoid-based heat stabilizer comprises cerium oxide and/or cerium oxyhydrate and wherein the polyamide composition has a cerium content ranging from 10 ppm to 9000 ppm; the second heat stabilizer comprises a copper based compound; the polyamide composition comprises at least 1 wppm amine/cerium/copper complex; and the polyamide composition has a tensile strength of at least 100 MPa, or at least 110 MPa, when heat aged for 3000 hours at a temperature of at least 180° C. and measured at 23° C.

Embodiment 21: An embodiment of any of embodiments 1-20, wherein the amide polymer has an amine end group level greater than 65 μeq/gram; the amide polymer comprises PA-6, PA-6,6, or PA-6,6/6T, or combinations thereof the lanthanoid-based heat stabilizer comprises a cerium-based heat stabilizer; the second heat stabilizer comprises a copper based compound; the polyamide composition has a cerium ratio ranging from 5.0 to 50.0; the polyamide composition comprises at least 1 wppm amine/cerium/copper complex; and the polyamide composition has a tensile strength of at least 100 MPa, or at least 110 MPa, when heat aged for 3000 hours at a temperature of at least 180° C. and measured at 23° C.

Embodiment 22: An embodiment of any of embodiments 1-21, further comprising from 1 wppm to 1 wt % cyclopentanone, optionally when heat aged for 3000 hours at a temperature of at least 180° C. and measured at 23° C.

Embodiment 23: A heat-stabilized polyamide composition comprising from 25 wt % to 99 wt % of an amide polymer having an amine end group level greater than 50 μeq/gram; a first stabilizer comprising a lanthanoid-based compound; a second stabilizer; and from 0 wt % to 65 wt % filler; wherein, when heat aged for 3000 hours over a temperature range of from 190° C. to 220° C., the polyamide composition demonstrates a tensile strength retention of greater than 51%, as measured at 23°.

Embodiment 24: An embodiment of embodiment 23, when heat aged for 2500 hours over a temperature range of from 190° C. to 220° C., the polyamide composition demonstrates a tensile strength retention of greater than 59%, as measured at 23° C.

Embodiment 25: An embodiment of any of embodiments 23 and 24, wherein when heat aged for 3000 hours over a temperature range of from 190° C. to 220° C., the polyamide composition demonstrates a tensile strength of greater than 102 MPa, as measured at 23° C.

Embodiment 26: An embodiment of any of embodiments 23-25, wherein, when heat aged for 2500 hours over a temperature range of from 190° C. to 220° C., the polyamide composition demonstrates a tensile strength of greater than 119 MPa, as measured at 23° C.

Embodiment 27: An embodiment of any of embodiments 23-26, wherein, when heat aged for 3000 hours over a temperature range of from 190° C. to 220° C., the polyamide composition demonstrates a tensile modulus of greater than 11110 MPa, as measured at 23° C.

Embodiment 28: An embodiment of any of embodiments 23-27, wherein, when heat aged for 3000 hours over a temperature range of from 190° C. to 220° C., the polyamide composition demonstrates an impact resilience of greater than 17 KJ/m², as measured at 23° C.

Embodiment 29: An embodiment of any of embodiments 23-28, wherein, when heat aged for 2500 hours at a temperature of 210° C.; the polyamide composition demonstrates a tensile strength greater than 99 MPa, as measured at 23° C.

Embodiment 30: An embodiment of any of embodiments 23-29, wherein, when heat aged for 3000 hours at a temperature of 210° C.; the polyamide composition demonstrates a tensile strength greater than 82 MPa, as measured at 23° C.

Embodiment 31: An embodiment of any of embodiments 23-30, wherein, when heat aged for 2500 hours at a temperature of 210° C.; the polyamide composition demonstrates a tensile strength retention greater than 50%, as measured at 23° C.

Embodiment 32: An embodiment of any of embodiments 23-31, wherein, when heat aged for 3000 hours at a temperature of 210° C.; the polyamide composition demonstrates a tensile strength retention greater than 41%, as measured at 23° C.

Embodiment 33: An embodiment of any of embodiments 23-32, wherein, when heat aged for 2500 hours at a temperature of 210° C.; the polyamide composition demonstrates an impact resilience greater than 17 KJ/m², as measured at 23° C.

Embodiment 34: An embodiment of any of embodiments 23-33, wherein, when heat aged for 3000 hours at a temperature of 210° C.; the polyamide composition demonstrates an impact resilience greater than 13 KJ/m², as measured at 23° C.

Embodiment 35: An embodiment of any of embodiments 23-34, wherein, when heat aged for 3000 hours at a temperature of 190° C.; the polyamide composition demonstrates an impact resilience greater than 17 KJ/m², as measured at 23° C.

Embodiment 36: An embodiment of any of embodiments 23-35, further comprising from 1 ppm to 1 wt % cyclopentanone.

Embodiment 37: An embodiment of any of embodiments 23-36, wherein the amide polymer has an amine end group level ranging from 60 μeq/gram to 105 μeq/gram.

Embodiment 38: An embodiment of any of embodiments 23-37, comprising at least 1 wppm amine/metal complex.

Embodiment 39: An embodiment of any of embodiments 23-38, wherein the composition comprises halide and the weight ratio of the first heat stabilizer to the halide ranges from 0.1 to 25.

Embodiment 40: An embodiment of any of embodiments 23-39, wherein the second heat stabilizer comprises a copper-based compound and wherein the second heat stabilizer is present in an amount ranging from 0.01 wt % to 5 wt %.

Embodiment 41: An embodiment of any of embodiments 23-40, wherein the lanthanoid-based heat stabilizer is a cerium-based heat stabilizer and wherein the lanthanoid-based heat stabilizer is present in an amount ranging from 0.01 wt % to 10 wt %.

Embodiment 42: An embodiment of any of embodiments 23-41, wherein the composition comprises an additional polyamide.

Embodiment 43: An embodiment of any of embodiments 23-42, wherein the lanthanoid-based compound comprises a lanthanoid ligand selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates. 2-ctbylhexanoates, or combinations thereof.

Embodiment 44: An embodiment of any of embodiments 23-43, wherein the first stabilizer is a lanthanoid-based compound and the second stabilizer is a copper-based compound; and wherein, when heat aged for 2500 hours at a temperature of 220° C., the polyamide composition demonstrates a tensile strength greater than 99 MPa and a tensile strength retention greater than 50%.

Embodiment 45: An embodiment of any of embodiments 23-44, wherein the amide polymer has an amine end group level greater than 65 μeq/gram; the lanthanoid-based compound comprises cerium oxide, cerium oxyhydrate, or cerium hydrate, or combinations thereof and wherein the polyamide composition has a cerium content ranging from 10 ppm to 9000 ppm; the second heat stabilizer comprises a copper-based compound; the polyamide composition comprises at least 1 wppm amine/cerium/copper complex; when heat aged for 2500 hours over a temperature range of from 190° C. to 220° C., the polyamide composition demonstrates a tensile strength retention of greater than 59%, as measured at 23° C.; and when heat aged for 3000 hours over a temperature range of from 190° C. to 220° C., the polyamide composition demonstrates an impact resilience of greater than 17 KJ/m², as measured at 23° C.

Embodiment 46: An embodiment of any of embodiments 23-45, wherein the amide polymer has an amine end group level greater than 65 μeq/gram; the amide polymer comprises PA-6,6; the composition further comprises an additional polyamide; the lanthanoid-based compound comprises a cerium-based compound; the second heat stabilizer comprises a copper-based compound; and when heat aged for 3000 hours at a temperature of 210° C.; the polyamide composition demonstrates a tensile strength greater than 82 MPa, as measured at 23° C.; when heat aged for 3000 hours at a temperature of 210° C.; the polyamide composition demonstrates a tensile strength retention greater than 41%, as measured at 23° C.; and when heat aged for 3000 hours at a temperature of 210° C.; the polyamide composition demonstrates an impact resilience greater than 13 KJ/m², as measured at 23° C.

Embodiment 47: An automotive part comprising the heat-stabilized polyamide composition of any of the previous embodiments, wherein, when heat aged for 3000 hours at a temperature of 210° C., the automotive part demonstrates an impact resilience greater than 13 kJ/m², as measured at 23° C.

Embodiment 48: An article for use in high temperature applications, wherein the article is formed from the heat-stabilized polyamide composition of any of the previous embodiments, wherein the article is used for fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit.

We claim:

1. A heat-stabilized polyamide composition comprising:
from 25 wt % to 99 wt % of an amide polymer having an amine end group level greater than 50 μeq/gram;
a first stabilizer comprising a lanthanoid-based compound;
a second stabilizer; and
from 0 wt % to 65 wt % filler;
wherein, when heat aged for 3000 hours over a temperature range of from 190° C. to 220° C., the polyamide composition demonstrates a tensile strength retention of greater than 51%, as measured at 23°.

2. The polyamide composition of claim 1, wherein, when heat aged for 2500 hours over a temperature range of from 190° C. to 220° C., the polyamide composition demonstrates a tensile strength retention of greater than 59%, as measured at 23° C.

3. The polyamide composition of claim 1, wherein, when heat aged for 3000 hours over a temperature range of from 190° C. to 220° C., the polyamide composition demonstrates a tensile strength of greater than 102 MPa, as measured at 23° C.

4. The polyamide composition of claim 1, wherein, when heat aged for 2500 hours over a temperature range of from 190° C. to 220° C., the polyamide composition demonstrates a tensile strength of greater than 119 MPa, as measured at 23° C.

5. The polyamide composition of claim 1, wherein, when heat aged for 3000 hours over a temperature range of from 190° C. to 220° C., the polyamide composition demonstrates a tensile modulus of greater than 11110 MPa, as measured at 23° C.

6. The polyamide composition of claim 1, wherein, when heat aged for 3000 hours over a temperature range of from 190° C. to 220° C., the polyamide composition demonstrates an impact resilience of greater than 17 KJ/m², as measured at 23° C.

7. The polyamide composition of claim 1, wherein, when heat aged for 2500 hours at a temperature of 210° C.; the polyamide composition demonstrates a tensile strength greater than 99 MPa, as measured at 23° C.

8. The polyamide composition of claim 1, wherein, when heat aged for 3000 hours at a temperature of 210° C.; the polyamide composition demonstrates a tensile strength greater than 82 MPa, as measured at 23° C.

9. The polyamide composition of claim 1, wherein, when heat aged for 2500 hours at a temperature of 210° C.; the polyamide composition demonstrates a tensile strength retention greater than 50%, as measured at 23° C.

10. The polyamide composition of claim 1, wherein, when heat aged for 3000 hours at a temperature of 210° C.; the polyamide composition demonstrates a tensile strength retention greater than 41%, as measured at 23° C.

11. The polyamide composition of claim 1, wherein, when heat aged for 2500 hours at a temperature of 210° C.; the polyamide composition demonstrates an impact resilience greater than 17 KJ/m², as measured at 23° C.

12. The polyamide composition of claim 1, wherein, when heat aged for 3000 hours at a temperature of 210° C.; the polyamide composition demonstrates an impact resilience greater than 13 KJ/m², as measured at 23° C.

13. The polyamide composition of claim 1, wherein, when heat aged for 3000 hours at a temperature of 190° C.; the polyamide composition demonstrates an impact resilience greater than 17 KJ/m², as measured at 23° C.

14. The polyamide composition of claim 1, further comprising from 1 ppm to 1 wt % cyclopentanone.

15. The polyamide composition of claim 1, wherein the amide polymer has an amine end group level ranging from 60 μeq/gram to 105 μeq/gram.

16. The polyamide composition of claim 1, comprising at least 1 wppm amine/metal complex.

17. The polyamide composition of claim 1, wherein the composition comprises halide and the weight ratio of the first heat stabilizer to the halide ranges from 0.1 to 25.

18. The polyamide composition of claim 1, wherein the second heat stabilizer comprises a copper-based compound and wherein the second heat stabilizer is present in an amount ranging from 0.01 wt % to 5 wt %.

19. The polyamide composition of claim 1, wherein the lanthanoid-based heat stabilizer is a cerium-based heat stabilizer and wherein the lanthanoid-based heat stabilizer is present in an amount ranging from 0.01 wt % to 10 wt %.

20. The polyamide composition of claim 1, wherein the composition comprises an additional polyamide.

21. The polyamide composition of claim 1, wherein the lanthanoid-based compound comprises a lanthanoid ligand selected from the group consisting of acetates, hydrates, oxyhydrates, phosphates, bromides, chlorides, oxides, nitrides, borides, carbides, carbonates, ammonium nitrates, fluorides, nitrates, polyols, amines, phenolics, hydroxides, oxalates, oxyhalides, chromoates, sulfates, or aluminates, perchlorates, the monochalcogenides of sulphur, selenium and tellurium, carbonates, hydroxides, oxides, trifluoromethanesulphonates, acetylacetonates, alcoholates, 2-ethylhexanoates, or combinations thereof.

22. The polyamide composition of claim 1, wherein the first stabilizer is a lanthanoid-based compound and the second stabilizer is a copper-based compound; and wherein, when heat aged for 2500 hours at a temperature of 220° C., the polyamide composition demonstrates a tensile strength greater than 99 MPa and a tensile strength retention greater than 50%.

23. The polyamide composition of claim 1, wherein:
the amide polymer has an amine end group level greater than 65 μeq/gram;
the lanthanoid-based compound comprises cerium oxide, cerium oxyhydrate, or cerium hydrate, or combinations thereof and wherein the polyamide composition has a cerium content ranging from 10 ppm to 9000 ppm;
the second heat stabilizer comprises a copper-based compound;
the polyamide composition comprises at least 1 wppm amine/cerium/copper complex;
when heat aged for 2500 hours over a temperature range of from 190° C. to 220° C., the polyamide composition demonstrates a tensile strength retention of greater than 59%, as measured at 23° C.; and
when heat aged for 3000 hours over a temperature range of from 190° C. to 220° C., the polyamide composition demonstrates an impact resilience of greater than 17 kJ/m², as measured at 23° C.

24. The polyamide composition of claim 1, wherein:
the amide polymer has an amine end group level greater than 65 μeq/gram
the amide polymer comprises PA-6,6;
the composition further comprises an additional polyamide;
the lanthanoid-based compound comprises a cerium-based compound;
the second heat stabilizer comprises a copper-based compound; and
when heat aged for 3000 hours at a temperature of 210° C.; the polyamide composition demonstrates a tensile strength greater than 82 MPa, as measured at 23° C.;
when heat aged for 3000 hours at a temperature of 210° C.; the polyamide composition demonstrates a tensile strength retention greater than 41%, as measured at 23° C.; and
when heat aged for 3000 hours at a temperature of 210° C.; the polyamide composition demonstrates an impact resilience greater than 13 KJ/m², as measured at 23° C.

25. An automotive part comprising the heat-stabilized polyamide composition of claim 1, wherein, when heat aged for 3000 hours at a temperature of 210° C., the automotive part demonstrates an impact resilience greater than 13 KJ/m², as measured at 23° C.

26. An article for use in high temperature applications, wherein the article is formed from the heat-stabilized polyamide composition of claim 1, wherein the article is used for fasteners, circuit breakers, terminal blocks, connectors, automotive parts, furniture parts, appliance parts, cable ties, sports equipment, gun stocks, window thermal breaks, aerosol valves, food film packaging, automotive/vehicle parts, textiles, industrial fibers, carpeting, or electrical/electronic parts.
